(19) United States
(12) Patent Application Publication
(10) Pub. No.: US 2024/0243888 A1
(43) Pub. Date: Jul. 18, 2024

(54) RECEIVED SIGNAL STRENGTH INDICATOR CONFIGURATION AND REPORTING

(71) Applicant: QUALCOMM INCORPORATED, San Diego, CA (US)

(72) Inventors: Yuwei Ren, Beijing (CN); Ruifeng Ma, Beijing (CN); Huilin Xu, Temecula, CA (US)

(21) Appl. No.: 18/557,542

(22) PCT Filed: Jul. 2, 2021
(86) PCT No.: PCT/CN2021/104230

§ 371 Date: Oct. 26, 2023

(51) Int. Cl. H04L 5/00; H04B 17/318; H04W 24/10; H04W 72/541

(52) U.S. Cl. CPC H04L 5/0073; H04B 17/318; H04L 5/0035; H04W 24/10; H04W 72/541

(57) ABSTRACT

Methods, systems, and devices for wireless communication at a user equipment (UE) are described. A UE may receive control signaling from a serving base station. The control signaling may indicate a resource pattern to monitor for interference caused by downlink transmissions from a second base station. The UE may then perform a received signal strength indicator measurement of the downlink transmissions from the second base station in accordance with the resource pattern. Upon performing the received signal strength indicator measurement, the UE may transmit a measurement report including an indication of the received signal strength indicator measurement.

### CROSS REFERENCE

The present Application is a 371 national stage filing of International PCT Application No. PCT/CN2021/104230 by Ren et al. entitled “RECEIVED SIGNAL STRENGTH INDICATOR CONFIGURATION AND REPORTING,” filed Jul. 2, 2021, which is assigned to the assignee hereof, and which is expressly incorporated by reference in its entirety herein.

### FIELD OF TECHNOLOGY

The following relates to wireless communication at a user equipment (UE), including received signal strength indicator configuration and reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). In some wireless communications systems, a first UE may be served by a first base station and a second UE may be served by a neighboring base station. However, in some examples, a signal from the neighboring base station may interfere with a reception at the first UE.

### SUMMARY

The described techniques relate to improved methods, systems, devices, and apparatuses that support received signal strength indicator configuration and reporting. Generally, the described techniques provide for techniques to utilize received signal strength indicator measurement to identify and report interference caused by downlink transmissions of a neighboring base station. In some examples, a serving base station may configure a user equipment (UE) with a received signal strength indicator resource pattern. The UE may perform a received signal strength indicator measurement of downlink transmissions from the neigh boring base station in accordance with the received signal strength indicator resource pattern. The UE may then transmit, to the serving base station, a measurement report including an indication of the received signal strength indicator measurement. In response to receiving the measurement report in a feedback from the UE, the serving base station may implement changes to adjust scheduling of the UE.

A method for wireless communication at a UE is described. The method may include receiving, from a serving base station, control signaling indicating a resource pattern to monitor for interference caused by downlink transmissions from a second base station, performing a received signal strength indicator measurement of the downlink transmissions from the second base station in accordance with the resource pattern, and transmitting, to the serving base station, a measurement report including an indication of the received signal strength indicator measurement.

An apparatus for wireless communication at a UE is described. The apparatus may include a processor, memory coupled with the processor, and instructions stored in the memory. The instructions may be executable by the processor to cause the apparatus to receive, from a serving base station, control signaling indicating a resource pattern to monitor for interference caused by downlink transmissions from a second base station, perform a received signal strength indicator measurement of the downlink transmissions from the second base station in accordance with the resource pattern, and transmit, to the serving base station, a measurement report including an indication of the received signal strength indicator measurement.

Another apparatus for wireless communication at a UE is described. The apparatus may include means for receiving, from a serving base station, control signaling indicating a resource pattern to monitor for interference caused by downlink transmissions from a second base station, means for performing a received signal strength indicator measurement of the downlink transmissions from the second base station in accordance with the resource pattern, and means for transmitting, to the serving base station, a measurement report including an indication of the received signal strength indicator measurement.

A non-transitory computer-readable medium storing code for wireless communication at a UE is described. The code may include instructions executable by a processor to receive, from a serving base station, control signaling indicating a resource pattern to monitor for interference caused by downlink transmissions from a second base station, perform a received signal strength indicator measurement of the downlink transmissions from the second base station in accordance with the resource pattern, and transmit, to the serving base station, a measurement report including an indication of the received signal strength indicator measurement.

Some examples of the method, apparatuses, and non-transitory computer-readable medium described herein may further include operations, features, means, or instructions for receiving the control signaling indicating a slot duration, a periodicity, a slot index, or any combination thereof, for the resource pattern, where the received signal strength indicator measurement may be performed based on at least one of the slot duration, the periodicity, or the slot index. Some examples of the method, apparatuses, and non-transitory computer-readable medium described herein may further include operations, features, means, or instructions for receiving the control signaling indicating to report a received signal strength indicator measurement for each resource of a set of multiple resources of the resource pattern.

Some examples of the method, apparatuses, and non-transitory computer-readable medium described herein may further include operations, features, means, or instructions for receiving the control signaling indicating that the UE may be to transmit the measurement report based on the received signal strength indicator measurement satisfying a threshold. Some examples of the method, apparatuses, and non-transitory computer-readable medium described herein may further include operations, features, means, or instructions for receiving the control signaling indicating a quantity number of resources from the resource pattern on which the UE may be to report, where the measurement report includes indications of received signal strength indicator measurements for the quantity number of resources from the resource pattern.

In some examples of the method, apparatuses, and non-transitory computer-readable medium described herein, transmitting the measurement report may include operations, features, means, or instructions for transmitting, to the serving base station, the measurement report including the received signal strength indicator measurement for a resource of the resource pattern, an index of the resource of the resource pattern, or both. Some examples of the method, apparatuses, and non-transitory computer-readable medium described herein may further include operations, features, means, or instructions for receiving, from the serving base station, the control signaling indicating that the resource pattern includes a cross link interference resource and a bit indicating for the UE monitor for interference caused by the downlink transmissions from the second base station using the cross link interference resource.

In some examples of the method, apparatuses, and non-transitory computer-readable medium described herein, receiving the control signaling may include operations, features, means, or instructions for receiving the control signaling indicating one or more parameters associated with the resource pattern, where the one or more parameters include at least one of a number of physical resource blocks, a starting physical resource block index for a measurement bandwidth, a symbol location of a received signal strength indicator resource in a slot, a number of slots, a reference subcarrier spacing for the received signal strength indicator measurement, a periodicity, a slot index, or a combination thereof.

Some examples of the method, apparatuses, and non-transitory computer-readable medium described herein may further include operations, features, means, or instructions for receiving timing assistance information corresponding to the downlink transmissions from the second base station, where the received signal strength indicator measurement may be performed based on the timing assistance information. Some examples of the method, apparatuses, and non-transitory computer-readable medium described herein may further include operations, features, means, or instructions for receiving the timing assistance information including a quasi-colocation parameter associated with a synchronization signal block transmission from the second base station and determining a timing of the synchronization signal block transmission based on the quasi-colocation parameter, where the received signal strength indicator measurement may be performed based on the timing.

Some examples of the method, apparatuses, and non-transitory computer-readable medium described herein may further include operations, features, means, or instructions for receiving, from the serving base station, the timing assistance information including an identifier of a second UE served by the second base station, receiving, from the second UE based on the identifier, a quasi-colocation parameter associated with a synchronization signal block transmission from the second base station, and determining a timing of the synchronization signal block transmission based on the quasi-colocation parameter, where the received signal strength indicator measurement may be performed based on the timing.

Some examples of the method, apparatuses, and non-transitory computer-readable medium described herein may further include operations, features, means, or instructions for transmitting UE capability information indicating a received signal strength indicator measurement capability for interference measurement, where the control signaling may be received based on the UE capability information. In some examples of the method, apparatuses, and non-transitory computer-readable medium described herein, the received signal strength indicator measurement capability indicates at least one of a maximum number of resources across a set of multiple slots the UE may be capable of measuring, a maximum number of measurement resources per slot the UE may be capable of measuring, or both.

Some examples of the method, apparatuses, and non-transitory computer-readable medium described herein may further include operations, features, means, or instructions for transmitting UE capability information indicating a joint measurement capability that identifies a number of resources the UE may be capable of measuring for cross link interference and neighbor cell interference, where the control signaling may be received based on the UE capability information. Some examples of the method, apparatuses, and non-transitory computer-readable medium described herein may further include operations, features, means, or instructions for transmitting UE capability information indicating a number of cross link interference resources the UE may be capable of measuring, where the control signaling may be received based on the UE capability information.

Some examples of the method, apparatuses, and non-transitory computer-readable medium described herein may further include operations, features, means, or instructions for receiving, from the serving base station and in response to the measurement report, a control message indicating a reference signal received power measurement resource, performing a reference signal received power measurement of the reference signal received power measurement resource, and transmitting a second measurement report including an indication of the reference signal received power measurement.

A method for wireless communication at a serving base station is described. The method may include transmitting, to a UE, control signaling indicating a resource pattern to monitor for interference caused by downlink transmissions from a second base station and receiving, from the UE, a measurement report including an indication of a received signal strength indicator measurement of the downlink transmissions from the second base station performed in accordance with the resource pattern.

An apparatus for wireless communication at a serving base station is described. The apparatus may include a processor, memory coupled with the processor, and instructions stored in the memory. The instructions may be executable by the processor to cause the apparatus to transmit, to a UE, control signaling indicating a resource pattern to monitor for interference caused by downlink transmissions from a second base station and receive, from the UE, a measurement report including an indication of a received signal strength indicator measurement of the downlink transmissions from the second base station performed in accordance with the resource pattern.

Another apparatus for wireless communication at a serving base station is described. The apparatus may include means for transmitting, to a UE, control signaling indicating a resource pattern to monitor for interference caused by downlink transmissions from a second base station and means for receiving, from the UE, a measurement report including an indication of a received signal strength indicator measurement of the downlink transmissions from the second base station performed in accordance with the resource pattern.

A non-transitory computer-readable medium storing code for wireless communication at a serving base station is described. The code may include instructions executable by a processor to transmit, to a UE, control signaling indicating a resource pattern to monitor for interference caused by downlink transmissions from a second base station and receive, from the UE, a measurement report including an indication of a received signal strength indicator measurement of the downlink transmissions from the second base station performed in accordance with the resource pattern.

Some examples of the method, apparatuses, and non-transitory computer-readable medium described herein may further include operations, features, means, or instructions for transmitting the control signaling indicating a slot duration, a periodicity, a slot index, or any combination thereof, for the resource pattern, where the received signal strength indicator measurement may be performed based on at least one of the slot duration, the periodicity, or the slot index. Some examples of the method, apparatuses, and non-transitory computer-readable medium described herein may further include operations, features, means, or instructions for transmitting the control signaling indicating to report a received signal strength indicator measurement for each resource of a set of multiple resources of the resource pattern.

Some examples of the method, apparatuses, and non-transitory computer-readable medium described herein may further include operations, features, means, or instructions for transmitting the control signaling indicating that the UE may be to transmit the measurement report based on the received signal strength indicator measurement satisfying a threshold. Some examples of the method, apparatuses, and non-transitory computer-readable medium described herein may further include operations, features, means, or instructions for transmitting the control signaling indicating a quantity number of resources from the resource pattern on which the UE may be to report, where the measurement report includes indications of received signal strength indicator measurements for the quantity number of resources from the resource pattern.

In some examples of the method, apparatuses, and non-transitory computer-readable medium described herein, receiving the measurement report may include operations, features, means, or instructions for receiving, from the UE, the measurement report including the received signal strength indicator measurement for a resource of the resource pattern, an index of the resource of the resource pattern, or both. Some examples of the method, apparatuses, and non-transitory computer-readable medium described herein may further include operations, features, means, or instructions for transmitting, to the UE, the control signaling indicating that the resource pattern includes a cross link interference resource and a bit indicating for the UE monitor for interference caused by the downlink transmissions from the second base station using the cross link interference resource.

In some examples of the method, apparatuses, and non-transitory computer-readable medium described herein, transmitting the control signaling may include operations, features, means, or instructions for transmitting the control signaling indicating one or more parameters associated with the resource pattern, where the one or more parameters include at least one of a number of physical resource blocks, a starting physical resource block index for a measurement bandwidth, a symbol location of a received signal strength indicator resource in a slot, a number of slots, a reference subcarrier spacing for the received signal strength indicator measurement, a periodicity, a slot index, or a combination thereof.

Some examples of the method, apparatuses, and non-transitory computer-readable medium described herein may further include operations, features, means, or instructions for transmitting timing assistance information corresponding to the downlink transmissions from the second base station, where the received signal strength indicator measurement may be performed based on the timing assistance information, the timing assistance information including a quasi-colocation parameter associated with a synchronization signal block transmission from the second base station or an identifier of a second UE served by the second base station.

Some examples of the method, apparatuses, and non-transitory computer-readable medium described herein may further include operations, features, means, or instructions for receiving UE capability information indicating a received signal strength indicator measurement capability for interference measurement, where the received signal strength indicator measurement capability indicates at least one of a maximum number of resources across a set of multiple slots the UE may be capable of measuring, a maximum number of measurement resources per slot the UE may be capable of measuring, or both, the control signaling being transmitted based on the UE capability information.

Some examples of the method, apparatuses, and non-transitory computer-readable medium described herein may further include operations, features, means, or instructions for receiving UE capability information indicating a joint measurement capability that identifies a number of resources the UE may be capable of measuring for cross link interference and neighbor cell interference, where the control signaling may be transmitted based on the UE capability information.

Some examples of the method, apparatuses, and non-transitory computer-readable medium described herein may further include operations, features, means, or instructions for receiving UE capability information indicating a number of cross link interference resources the UE may be capable of measuring, where the control signaling may be transmitted based on the UE capability information. Some examples of the method, apparatuses, and non-transitory computer-readable medium described herein may further include operations, features, means, or instructions for transmitting, to the UE and in response to the measurement report, a control message indicating a reference signal received power measurement resource and receiving a second measurement report including an indication of a reference signal received power measurement of the reference signal received power measurement resource.

### BRIEF DESCRIPTION OF THE DRAWINGS

FIG. 1 illustrates an example of a wireless communications system that supports received signal strength indicator configuration and reporting in accordance with aspects of the present disclosure.

FIG. 2 illustrates an example of a wireless communications system that supports received signal strength indicator configuration and reporting in accordance with aspects of the present disclosure.

FIG. 3 illustrates an example of a process flow that supports received signal strength indicator configuration and reporting in accordance with aspects of the present disclosure.

FIG. 4 illustrates an example of a received signal strength indicator resource configuration that supports received signal strength indicator configuration and reporting in accordance with aspects of the present disclosure.

FIG. 5 illustrates an example of a process flow that supports received signal strength indicator configuration and reporting in accordance with aspects of the present disclosure.

FIGS. 6 and 7 show block diagrams of devices that support received signal strength indicator configuration and reporting in accordance with aspects of the present disclosure.

FIG. 8 shows a block diagram of a communications manager that supports received signal strength indicator configuration and reporting in accordance with aspects of the present disclosure.

FIG. 9 shows a diagram of a system including a device that supports received signal strength indicator configuration and reporting in accordance with aspects of the present disclosure.

FIGS. 10 and 11 show block diagrams of devices that support received signal strength indicator configuration and reporting in accordance with aspects of the present disclosure.

FIG. 12 shows a block diagram of a communications manager that supports received signal strength indicator configuration and reporting in accordance with aspects of the present disclosure.

FIG. 13 shows a diagram of a system including a device that supports received signal strength indicator configuration and reporting in accordance with aspects of the present disclosure.

FIGS. 14 through 17 show flowcharts illustrating methods that support received signal strength indicator configuration and reporting in accordance with aspects of the present disclosure.

### DETAILED DESCRIPTION

In wireless communications systems, a user equipment (UE) and one or more base stations may communicate with each other. For instance, a first UE may be served by a first base station and a second UE may be served by a second base station (e.g., neighboring base station). When both base stations are in simultaneous communication, a signal from the second base station (e.g., neighboring base station) may interfere with a reception at the first UE. Similarly, a signal from the first base station may interfere with a reception at the second UE. Such an interference may be referred to as downlink jamming. To reduce downlink jamming, some wireless communications systems may provide for UEs to use channel state information reference signals to identify an interference level. The UEs may then explicitly report the downlink jamming or the interference level, based on the channel state information reference signals. However, reference signal-based interference management may be perform using a channel state information reference signal configuration. In some examples, the measurement using the channel state information reference signal may not be available.

Aspects of the present disclosure provide for techniques to utilize received signal strength indicator measurement to identify and report downlink jamming (interference caused by downlink transmissions of a neighboring base station). In some examples, a UE may receive a control signaling from a serving base station. The control signaling may indicate a received signal strength indicator resource pattern to monitor for interference caused by downlink transmission from a second base station (e.g., neighboring base station). For example, the resource pattern may indicate a resource configuration for received signal strength indicator measurement. The UE may perform a received signal strength indicator measurement of the downlink transmission from the second base station in accordance with the resource pattern. The UE may then report the received signal strength indicator measurement to the serving base station. The serving base station may adjust scheduling of the UE to avoid downlink jamming by the neighbor base station based on the feedback from the UE.

Particular aspects of the subject matter described herein may be implemented to realize one or more advantages. The described techniques may support improvements in interference management in wireless communications systems by reducing signaling overhead. Further, in some examples, the interference management using a resource pattern as described herein may support higher data rates, thereby improving latency and reliability. As such, supported techniques may include improved network operations, and, in some examples, may promote network efficiencies, among other benefits

Aspects of the disclosure are initially described in the context of wireless communications systems. Aspects of the disclosure are further illustrated by a received signal strength indicator resource configuration and process flows. Aspects of the disclosure are further illustrated by and described with reference to apparatus diagrams, system diagrams, and flowcharts that relate to received signal strength indicator configuration and reporting.

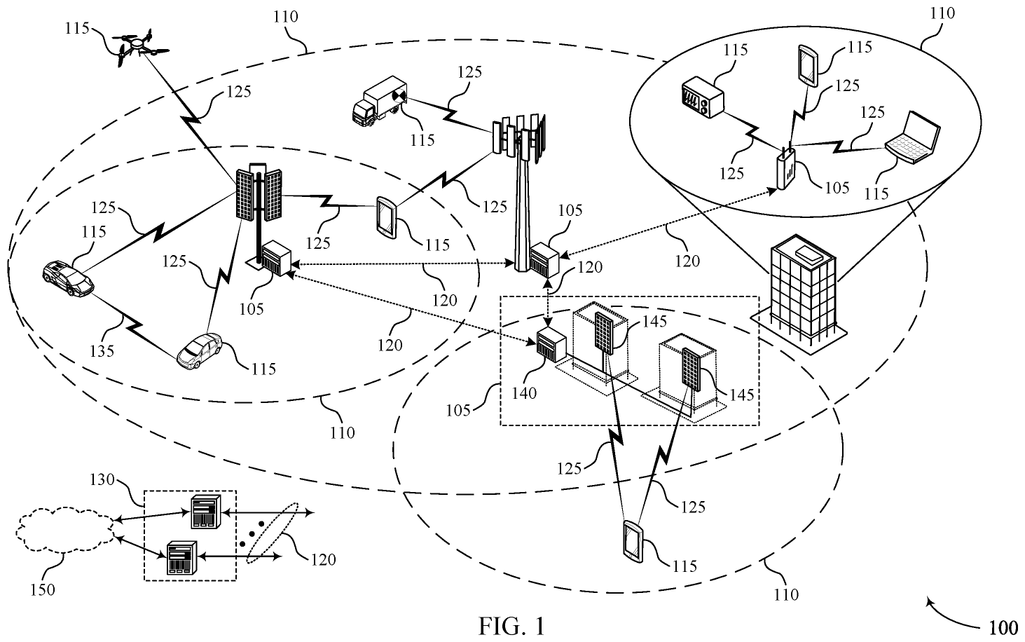

FIG. 1 illustrates an example of a wireless communications system 100 that supports received signal strength indicator configuration and reporting in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example in the range of 300 megahertz. (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHZ.

The wireless communications system 100 may also operate in a super high frequency (SHF) region using frequency bands from 3 GHZ to 30 GHZ, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Some wireless communications systems may experience cross link interference among different links. Cross link interference may be experienced from dynamic frame configuration. For example, cross link interference may occur between two or more base stations or UEs (between uplink and downlink). In the case if cross link interference between two UEs, reference signal received power and received signal strength indicator may be configured to measure the interference. Additionally or alternatively, cross link interference may be from aligned frames. In some examples, a first UE may be served by a first base station and a second UE may be served by a neighboring base station. Often times, a signal from the neighboring base station may interfere with a reception at the first UE. Similarly, a signal from the first base station may interfere with a reception at the second UE. Such interference may be known as downlink jamming.

In some examples, the interference (cross link interference) may be from one UE to another nearby UE. Cross link interference may occur when a base station configures different time domain uplink and downlink slot formats to nearby UEs. When a first UE is transmitting, a second UE (not the intended recipient) may receive this transmission as cross link interference in its downlink symbols if first UE's uplink symbol collides with at least one downlink symbol of second UE. In addition, the cross link interference can occur between two UEs on the same cell or on different cells. In some examples, the second UE may participate in a signaling and procedure to measure cross link interference from the first UE. In such cases, the first UE may not transmit a dedicated signal for cross link interference measurement by another UE and is not aware of an uplink transmission measured by the second UE. The second UE may measure the cross link interference if the base station configures one or more cross link interference measurement resources to it. The cross link interference measurement may defined as periodic measurement based on sounding reference signal reference signal received power or received signal strength indicator. Based on the cross link interference measurement report, the base station can manage the scheduling of UEs to balance the throughput of different UEs. In some examples, a channel state information report may include a channel quality indicator, a precoding matrix indicator, a channel state information reference signal resource indicator, a strongest layer indication, a rank indication and a reference signal received power for beam management.

Higher layer configuration at UE may include N≥1 channel state information reporting settings, M≥1 resource settings, and L≥1 channel state information measurement links. If channel state information interference measurement resources are configured in a resource setting, channel state information interference measurement resources may be used got inter-cell interference measurement and the channel state information interference measurement resources can be shared with UEs within the serving cell. Interference information may be implicitly indicated as a feedback to the base station via channel quality indication (quantized spectrum efficiency). The configurations can support the reference signal-based L1 and L3 inter-cell interference measurement.

Some wireless communications systems support L3 channel state information reference signal for L3 reference signal receive power measurement. However, such L3 channel state information reference signal measurement techniques are deficient. In comparison to L3 reference signal receive power, L3 received signal strength indicator may have one or more advantages. The received signal strength indicator can be measured with low complexity. For example, a maximum received signal strength indicator resource supported by UE may be much larger (at least twice) than that for reference signal receive power measurement resources. In some instances. a per slot maximum number of received signal strength indicator resources may not be used by the wireless communications system. In comparison, a maximum number of reference signal receive power resources per slot may be defined, which is much smaller than the total number of reference signal receive power resources across a slot. Additionally or alternatively, received signal strength indicator measurement may be captured from any neighboring cell downlink transmission (e.g., physical downlink shared channel, physical downlink control channel) that may affect the UE. That is, there may be a lot of more opportunities for the UE to measure the received signal strength indicator.

In some examples, received signal strength indicator measurement may reflect the time domain uplink and downlink configuration difference between the serving cell and neighboring cells. This can be more stable than the channel state information reference signal configuration for neighboring cell's UEs. The configuration of channel state information reference signal for neighboring cells may frequently change. In contrast, the configuration of received signal strength indicator measurement can be less often updated. Thus, received signal strength indicator measurement may have less signaling overhead for the configuration.

In some instances, a reference signal for channel state information may not explicitly indicate the interference level. The reference signal-based interference measurement can be L1 or L3 configuration. However, the reference signal-based management may include a reference signal configuration. Thus, such measurements may not be available. In addition, the reference signal-based measurement may involve large resource cost, and the corresponding channel state information reference signal reference signal receive power processing may be more complicated. In some examples, radio frequency and timing advance tracking may not be accurate for interference measurement. For example, a default downlink reception timing advance may not match a received timing advance from adjacent cells.

According to one or more aspects of the present disclosure, the UE 115 and the base station 105 may support a received signal strength indicator configuration for the downlink jamming interference management from adjacent cells. As such, the received signal strength indicator measurement may be used with one configuration (e.g., one static configuration), with limited configuration cost. In addition, the received signal strength indicator may not have a high reception complexity. The received signal strength indicator resource may also be available, and the UE 115 can detect the interference at any time.

In some examples, a UE 115 may receive a control signaling from a serving base station 105. The control signaling may indicate a resource pattern (e.g., a received signal strength indicator resource pattern) to monitor for interference caused by downlink transmission from a second base station 105 (e.g., neighboring base station). The UE 115 may perform a received signal strength indicator measurement of the downlink transmission from the second base station 105 in accordance with the resource pattern. The UE 115 then reports the received signal strength indicator measurement to the serving base station 105. The serving base station 105 may adjust scheduling of the UE 115 to avoid downlink jamming by the neighbor base station 105 based on the feedback from the UE 115.

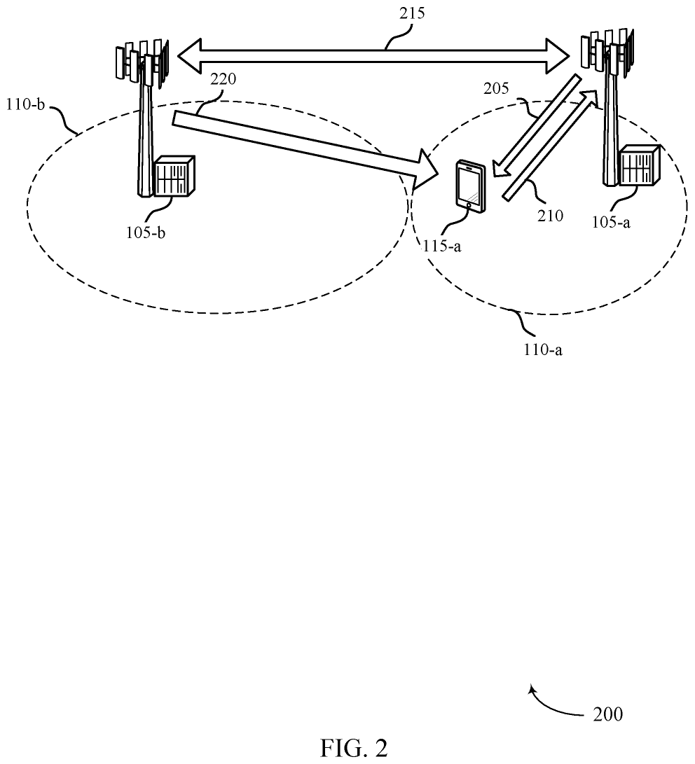

FIG. 2 illustrates an example of a wireless communications system 200 that supports received signal strength indicator configuration and reporting in accordance with aspects of the present disclosure. In some examples, the wireless communications system 200 may implement or be implemented by aspects of the wireless communications system 100. For example, the wireless communications system 200 may include a UE 115-a, a base station 105-a and a base station 105-b, which may be examples of a UE 115 and a base station 105 as described with reference to FIG. 1.

The base station 105-a may be a serving base station for the UE 115-a and the base station 105-b may be a neighboring base station (e.g., a second base station). The UE 115-a may communicate with the base station 105-a in a geographic coverage area 110-a supported by the base station 105-a. Additionally, the UE 115-a may communicate with the base station 105-b in a geographic coverage area 110-b supported by the base station 105-b. The geographic coverage area 110-a and the geographic coverage area 110-b may be examples of a geographic coverage area 110 as described with reference to FIG. 1.

As depicted in the example of FIG. 1, the base station 105-a may transmit one or more downlink signals to the UE 115-a via a communications link 205 (e.g., a downlink communications link) and the UE 115-a may transmit one or more uplink signals to the base station 105-a via a communications link 210 (e.g., an uplink communications link). In some cases, the UE 115-a may be configured by the base station 105-a with a resource pattern. In particular, the UE 115-a may receive, from the serving base station 105-a, control signaling indicating the resource pattern to monitor for interference caused by downlink transmissions from a second base station 105-b.

In some wireless communications systems, a first UE may be served by a first base station and a second UE may be served by a neighboring base station. Often, a signal from the neighboring base station may interfere with a reception at the first UE. Similarly, a signal from the first base station may interfere with a reception at the second UE. Such interference may be referred to as downlink jamming. To reduce downlink jamming, some wireless communications systems may provide for UEs to use channel state information reference signals to identify an interference level. The UEs may explicitly report the downlink jamming or the interference level, based on the channel state information reference signal. However, the reference signal-based interference management may not be available.

One or more aspects of the present disclosure provide for a method to utilize received signal strength indicator measurement to identify and report downlink jamming. As depicted in the example of FIG. 2, the UE 115-a may identify the downlink jamming 220 caused by the base station 105-b. The base station 105-a (serving base station) and the base station 105-b (neighboring base station) may perform a slot format exchange using a communications link 215. The UE 115-a may receive control signaling via the communications link 205. The control signaling may indicate a resource pattern to monitor for interference caused by downlink transmission from a second base station (e.g., neighboring base station 105-b). The serving base station 105-a may use the slot format of the neighboring base station 105-b to select the resource pattern. For example, the resource pattern may indicates time and frequency resources in which the neighboring base station 105-b is transmitting downlink signaling in accordance with its slot format. The serving base station 105-a may send control signaling that indicates the resource pattern to enable the UE 115-a to perform received signal strength indicator (RSSI) measurement of one or more resources indicated in the resource pattern. For example, the UE 115-a may perform a received signal strength indicator measurement of the downlink transmissions from the second base station 105-b in accordance with the resource pattern. In some examples, the received signal strength indicator resource associated with downlink signals may be at least one of a physical downlink shared channel, a demodulation reference signal, a physical downlink control channel, or a combination thereof.

The UE 115-a may then report the received signal strength indicator measurement to the serving base station 105-a. Upon receiving the measurement report from the UE 115-a, the serving base station 105-a may adjust scheduling of the UE 115-a to avoid downlink jamming by the neighbor base station 105-b based on the feedback from the UE 115-a. Thus, the aspects depicted herein provide a received signal strength indicator configuration and measurement reporting. The procedure for received signal strength indicator configuration and reporting may be transparent to the neighboring base station 105-b. The techniques depicted herein may also be achieved with a dedicated resource for the received signal strength indicator measurement.

In some examples, the network (or serving base station 105-a) may configure the conditions, which triggers the received signal strength indicator measurement reporting by the UE 115-a. For example, the UE 115-a may be configured to report RSSI measurement of each resource of the configured received signal strength indicator resources in the resource pattern. That is, in a default mode, the UE 115-a may receive the control signaling indicating to report a received signal strength indicator measurement for each resource of a set of resources of the resource pattern. In some examples, the serving base station 105-a may configure the UE 115-a to report the received signal strength indicator resource measurement when larger than the pre-defined threshold, and an identifier of the resource (e.g., a resource index). The pre-defined threshold may be indicated using a threshold message configuration in a received signal strength indicator RRC signaling. In another example, the UE 115-a may receive the control signaling indicating that the UE is to transmit the measurement report when a received signal strength indicator measurement of any resource in the set of resources of the resource pattern satisfies a threshold and may also indicate the measured resource (e.g., a resource index).

Additionally or alternatively, in a given resource pattern, the UE 115-a may be configured to report K received signal strength indicator resources with the largest observed RSSI values. A configuration for the K values may be indicated to the UE 115-a via received signal strength indicator RRC signaling. For example, the UE 115-a may receive the control signaling indicating a quantity number of resources from the resource pattern on which the UE is to report. In some examples, the measurement report may include indications of received signal strength indicator measurements for the quantity number of resources from the resource pattern. For example, the control signaling may configure the UE 115-a to report the K resources in the resource pattern having the highest received signal strength indicator measurements. For example, the resource pattern may include 10 different time and frequency resources. The UE may report the 4 resources having the highest observed received signal strength indicator measurements, a respective index of the 4 resources, and indicate a respective RSSI measurement for the 4 resources.

According to one or more aspects depicted herein, the serving base station 105-a may configure the UE 115-a to report information based on the received signal strength indicator resource. In some instances, the serving base station 105-a may configure the UE 115-a to report measurement results for the reported received signal strength indicator resources and a received signal strength indicator resource index. That is, the UE 115-a may transmit, to the serving base station 105-a, the measurement report including the received signal strength indicator measurement for a resource of the resource pattern, an index of the resource of the resource pattern, or both.

A cross link interference resource may be used by one a UE to perform cross link interference measurement between two or more UEs. For instance, the interference may be from an uplink transmission of a first UE to a downlink reception of a second UE. In some examples, the cross link interference resource can be re-used for downlink jamming received signal strength indicator measurement. For instance, the UE 115-a may use resources configured for measuring cross link interference to perform the received signal strength indicator measurement of downlink jamming by a base station. For example, the UE 115-a may receive, from the serving base station 105-a, the control signaling indicating that the resource pattern includes a cross link interference resource and a bit indicating for the UE monitor for interference caused by the downlink transmissions from the second base station 105-b using the cross link interference resource. In the control signaling (RRC signaling) indicating the cross link interference-received signal strength indicator configuration, the serving base station 105-a may include the one element (e.g., 1 bit) to indicate whether the measurement is of downlink jamming or cross link interference between UEs. Cross link interference received signal strength indicator and downlink jamming received signal strength indicator measurements may hold different configurations (e.g., measurement timing). In some examples, the one element (e.g., 1 bit) may indicate to the UE 115-a how to make the measurement of the received signal strength indicator.

The UE 115-a may transmit UE capability information indicating a received signal strength indicator measurement capability for interference measurement, where the control signaling is received based on the UE capability information. The received signal strength indicator measurement capability may indicate at least one of a defined or maximum number of resources across a plurality of slots the UE is capable of measuring, a defined or maximum number of measurement resources per slot the UE is capable of measuring, or both. According to some aspects, a received signal strength indicator measurement capability may be defined for jamming measurement for at least one of the defined or maximum number of received signal strength indicator measurement resources across slots, the defined or maximum number of received signal strength indicator measurement resources per slot, or both. In some examples, a joint received signal strength indicator measurement capability may be defined for total resource number of cross link interference received signal strength indicator resources and received signal strength indicator resources for neighbor cell measurement. For example, the serving base station 105-a may define the overall number of the resources for jamming measurement to not be larger than 20. The UE 115-a may transmit UE capability information indicating a joint measurement capability that identifies a number of resources the UE is capable of measuring for cross link interference and neighbor cell interference. In some examples, the control signaling may be received based on the UE capability information.

In some examples, the UE 115-a may transmit a capability to reuse the capability for the defined or maximum number of cross link interference received signal strength indicator measurement resources. The UE 115-a may transmit UE capability information indicating a number of cross link interference resources the UE is capable of measuring. In some examples, the control signaling may be received based on the UE capability information. Thus, the UE that supports cross link interference received signal strength indicator measurement can also afford the complexity for received signal strength indicator neighbor cell measurement for downlink jamming management.

In some examples, the UE 115-a may receive, from the serving base station 105-a, the timing assistance information including an identifier of a second UE served by the second base station 105-b. The UE 115-a may then receive, from the second UE based on the identifier, a quasi-colocation parameter associated with a synchronization signal block transmission from the second base station 105-b. For instance, if UEs are close to the one neighbor cell's UE, then it may be assumed that the two UEs hold the same downlink timing. The UE 115-a may then determine a timing of the synchronization signal block transmission for the neighbor base station based on the quasi-colocation parameter. In some examples, the received signal strength indicator measurement may be performed based on the timing. In other cases, the UE 115-a may directly use self-downlink reception timing to measure the received signal strength indicator for downlink jamming. In some examples, the received signal strength indicator timing indication configuration may be defined in the RRC message (RSSI-Measurement-ResourceConfig-DL jamming). The configuration may include an indication of synchronization signal block for timing or UE identifier for timing. The RRC message may further indicate the corresponding quasi-colocation parameter. In some examples, the RRC message may indicate the UE to use the self-downlink reception timing.

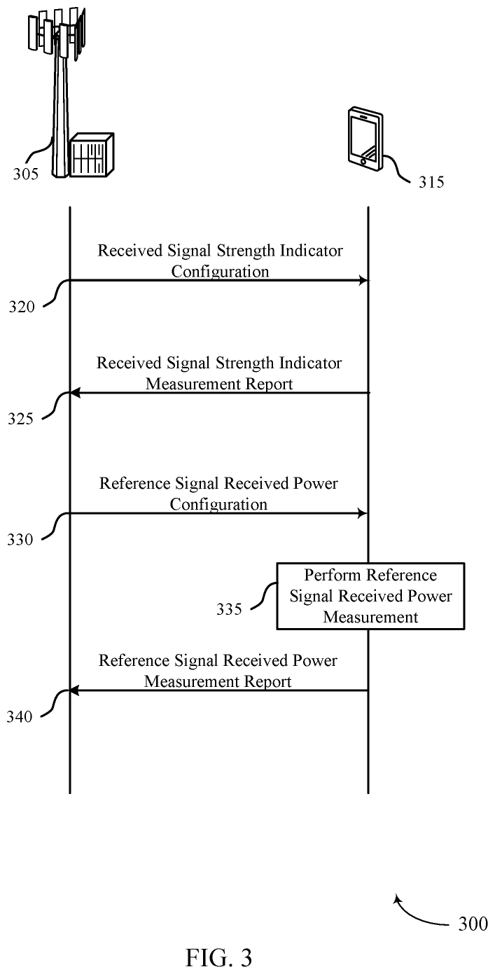

FIG. 3 illustrates an example of a process flow 300 that supports received signal strength indicator configuration and reporting in accordance with aspects of the present disclosure. In some examples, the process flow 300 may implement aspects of wireless communications system 100 and the wireless communications system 200 described with reference to FIGS. 1 and 2, respectively. For example, the process flow 300 may be based on one or more rules for received signal strength indicator configuration and reporting in wireless communications systems. The process flow 300 describes a low complicity procedure for neighbor cell interference measurement and identification. The process flow 300 may be implemented by the UE 315 and the base station 305 for reduced power consumption, and may promote low latency and low interference for wireless communications supporting high priority channels, among other benefits. The base station 305 and the UE 315 may be examples of a base station 105 and a UE 115, as described with reference to FIGS. 1 and 2.

In the following description of the process flow 300, the operations between the base station 305 and the UE 315 may be transmitted in a different order than the example order shown, or the operations performed by the base station 305 and the UE 315 may be performed in different orders or at different times. Some operations may also be omitted from the process flow 300, and other operations may be added to the process flow 300.

The base station 305 may be a serving base station. A serving cell (including the base station 305) may configure the UE 315 to measure received signal strength indicator for jamming caused by signals transmitted from neighboring cells. Additionally or alternatively, the UE 315 may be configured with received signal strength indicator measurement resources for multiple neighboring cells.

At 320, the base station 305 may transmit a received signal strength indicator configuration. For example, the base station 505 may transmit a control signaling indicating a resource pattern to monitor for interference caused by downlink transmissions from a second base station.

At 325, the UE 315 may transmit a measurement report including an indication of a received signal strength indicator measurement of the downlink transmissions from the second base station performed in accordance with the resource pattern. In some examples, the UE 315 may report the measurement result to the base station 305 if the measurement for a resource is above a threshold. In some examples, the UE 315 may report received signal strength indicator measurement based on an event triggered report for a neighboring cell (e.g., when a strong jamming signal received signal strength indicator is detected).

At 330, the base station 305 may transmit a reference signal received power configuration. The base station 305 may transmit, in response to the measurement report, a control message indicating a reference signal received power measurement resource. For example, the base station 305 may configure reference signal received power measurement channel state information reference signal resources for neighbor cells reported by the UE 315.

At 335, the UE 315 performs a reference signal received power measurement of the reference signal received power measurement resource. At 340, the UE 315 may transmit a measurement report including an indication of the reference signal received power measurement. In some examples, the measurement report may be a periodic measurement report.

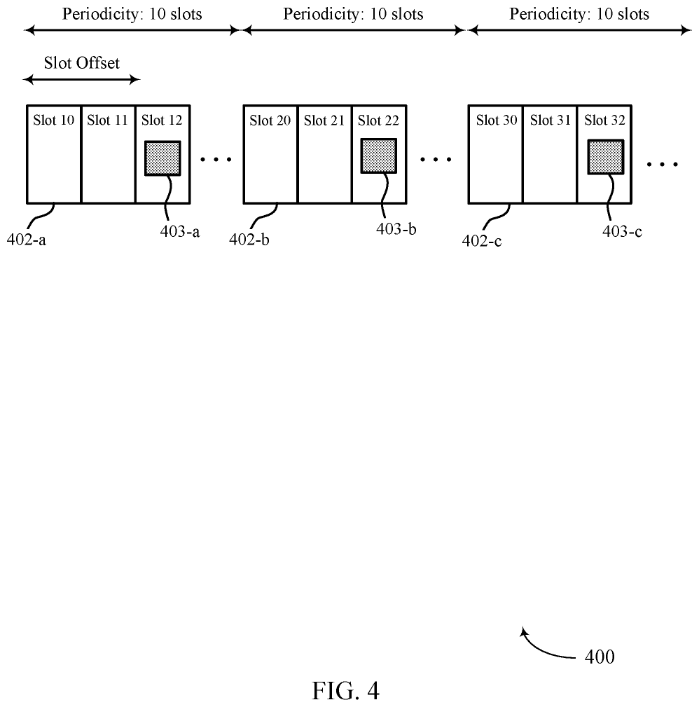

FIG. 4 illustrates an example of a received signal strength indicator resource configuration 400 that supports received signal strength indicator configuration and reporting in accordance with aspects of the present disclosure. In some examples, the received signal strength indicator resource configuration 400 may implement aspects of wireless communications system 100 and the wireless communications system 200 as depicted with reference to FIGS. 1 and 2. In some examples, the received signal strength indicator resource configuration 400 may be implemented by a base station 105 and one or more UEs 115. The base station 105 and the UE 115 may be examples of a base station 105 and a UE 115, as described with reference to FIGS. 1 and 2.

According to one or more aspects, a UE may receive, from a serving base station, control signaling indicating a resource pattern to monitor for interference caused by downlink transmissions from a second base station. In some examples, the control signaling may be RRC signaling. In some examples, the UE may receive the control signaling indicating a slot duration, a periodicity, a slot index, or any combination thereof, for the resource pattern. The RRC message (RSSI-Measurement-ResourceConfig-DL jamming) may include an allowed size of the measurement bandwidth (nrofPRBs), a starting physical resource block index of the measurement bandwidth (startPRB), an OFDM symbol location of the received signal strength indicator resource within a slot (startPosition), a reference subcarrier spacing for received signal strength indicator measurement (Reference-Subcarrier-Spacing), and periodicity and the slot index to indicate the slot pattern (PeriodicityAndOffset). The RRC message may further indicate a number of symbols (nrofSymbols). Within a slot that is configured for received signal strength indicator measurement, the UE may measure the received signal strength indicator from startPosition to startPosition+nrofSymbols−1. The UE may then perform a received signal strength indicator measurement of the downlink transmissions from the second base station in accordance with the resource pattern. In some examples, the received signal strength indicator measurement may be performed based on at least one of the slot duration, the periodicity, or the slot index.

As depicted in the example of FIG. 4, a base station may configure a slot duration of a resource pattern for received signal strength indicator measurement, which corresponds to one value of periodicity among the periodicity set (i.e., {10 ms, 20 ms, 40 ms, 80 ms, 160 ms, 320 ms, 640 ms}). In some examples, the base station may configure the slot index in the periodicity, as shown in Table 1:

TABLE 1

| Periodicity set | Slot index |
|---|---|
| Slots 10 | INTEGER (0 . . . 9) |
| Slots 20 | INTEGER (0 . . . 19) |
| Slots 40 | INTEGER (0 . . . 39) |
| Slots 80 | INTEGER (0 . . . 79) |
| Slots 160 | INTEGER (0 . . . 159) |
| . . . | . . . |

The UE may determine a location of received signal strength indicator resource 403 based on receiving the RRC signaling. The RRC signaling may indicate a periodicity of 10 slots and an offset of 2 slots, to indicate the resource pattern that the UE is to measure for RSSI. The RRC signaling may further indicate that the received signal strength indicator resource is located at a time period starting with slot 402-a (e.g., slot 10). The received signal strength indicator resource may occur periodically and is located at a time period starting with slot 402-b (e.g., slot 20) and at a time period starting with slot 402-c (e.g., slot 30). As depicted in the example of FIG. 4, the UE may determine that the received signal strength indicator resource 403-a is location in slot 12 (by applying an offset of 2 slots starting from slot 10). Similarly, the UE may determine that the received signal strength indicator resource 403-b is location in slot 22 (by applying an offset of 2 slots starting from slot 20). Additionally or alternatively, the UE may determine that the received signal strength indicator resource 403-c is location in slot 32 (by applying an offset of 2 slots starting from slot 30). Within a slot that is configured for received signal strength indicator measurement, the UE may measure the received signal strength indicator from startPosition to startPosition (3)+nrofSymbols(3)−1. For example, with a starting physical resource block index 1, the UE may calculate a number of resource blocks (e.g., 8 resource blocks starting from resource block 1 to resource block 8).

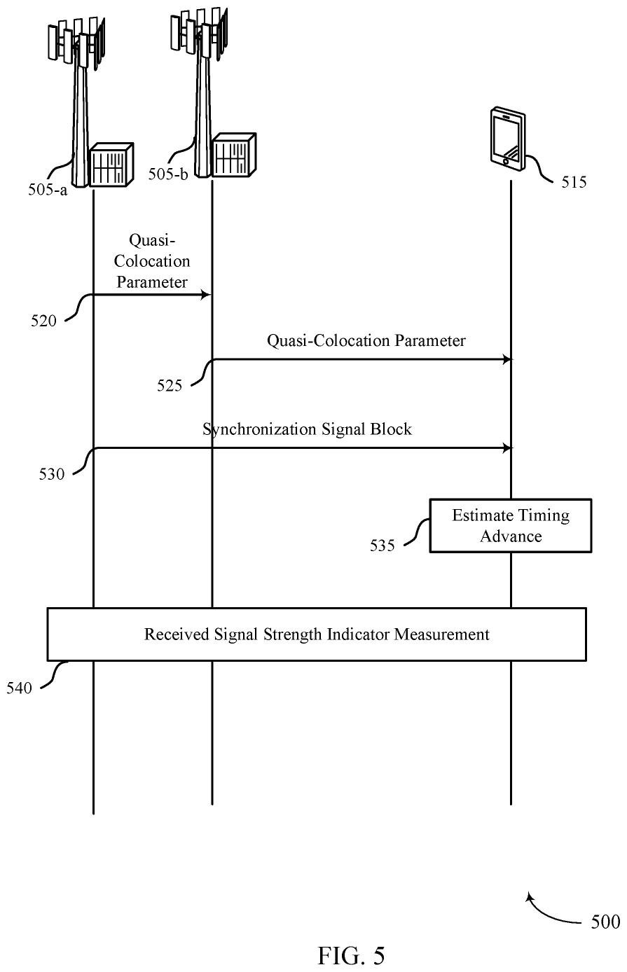

FIG. 5 illustrates an example of a process flow 500 that supports received signal strength indicator configuration and reporting in accordance with aspects of the present disclosure. In some examples, the process flow 500 may implement aspects of wireless communications system 100 and the wireless communications system 200 described with reference to FIGS. 1 and 2, respectively. For example, the process flow 500 may be based on one or more rules for received signal strength indicator configuration and reporting in wireless communications systems. The process flow 500 may be implemented by the UE 515, a serving base station 505-b and a neighboring base station 505-a for reduced power consumption, and may promote low latency and low interference for wireless communications supporting high priority channels, among other benefits. The UE 515, the serving base station 505-b and the neighboring base station 505-a may be examples of a base station 105 and a UE 115, as described with reference to FIGS. 1 and 2.

In the following description of the process flow 500, the operations between the UE 515, the serving base station 505-b and the neighboring base station 505-a may be transmitted in a different order than the example order shown, or the operations performed by the UE 515, the serving base station 505-b and the neighboring base station 505-a may be performed in different orders or at different times. Some operations may also be omitted from the process flow 500, and other operations may be added to the process flow 500. According to aspects depicted herein, the UE 515 may receive timing assistance information corresponding to the downlink transmissions from the neighboring base station 505-a.

At 520, the neighboring base station 505-a may transmit, to the serving base station 505-b, a quasi-colocation parameter associated with a synchronization signal block transmission. At 525, the serving base station 505-a may transmit, to the UE 515, the quasi-colocation parameter associated with a synchronization signal block transmission. As depicted herein, the UE 515 may receive the timing assistance information including a quasi-colocation parameter associated with a synchronization signal block transmission from the neighboring base station 505-a. For example, the serving base station 505-b may configure the UE 515 with the quasi-colocation parameter with a neighboring cell's synchronization signal block, for the UE 515 to determine timing of the received signal strength indicator measurement for downlink jamming. The configured quasi-colocation parameter may be helpful for the UE 515 to estimate the synchronization signal block, and to determine the timing for the received signal strength indicator measurement.

At 530, the UE 515 may receive a synchronization signal block from the neighboring base station 505-a. At 535, the UE 515 may determine a timing of the synchronization signal block transmission based on the quasi-colocation parameter, and may use the determined timing for performing RSSI measurements of other downlink transmissions by the neighboring base station 505-a. At 540, the UE 515 performs at least one received signal strength indicator measurement of one or more downlink transmissions by the neighboring base station 505-a in at least one resource of the resource pattern using the timing.

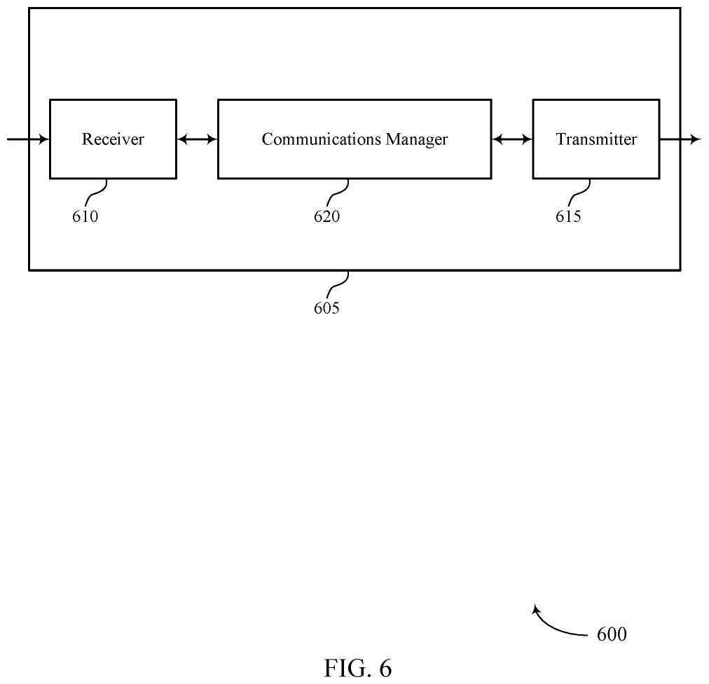

FIG. 6 shows a block diagram 600 of a device 605 that supports received signal strength indicator configuration and reporting in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to received signal strength indicator configuration and reporting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to received signal strength indicator configuration and reporting). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of received signal strength indicator configuration and reporting as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for receiving, from a serving base station, control signaling indicating a resource pattern to monitor for interference caused by downlink transmissions from a second base station. The communications manager 620 may be configured as or otherwise support a means for performing a received signal strength indicator measurement of the downlink transmissions from the second base station in accordance with the resource pattern. The communications manager 620 may be configured as or otherwise support a means for transmitting, to the serving base station, a measurement report including an indication of the received signal strength indicator measurement.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for reduced processing, reduced power consumption, and more efficient utilization of communication resources.

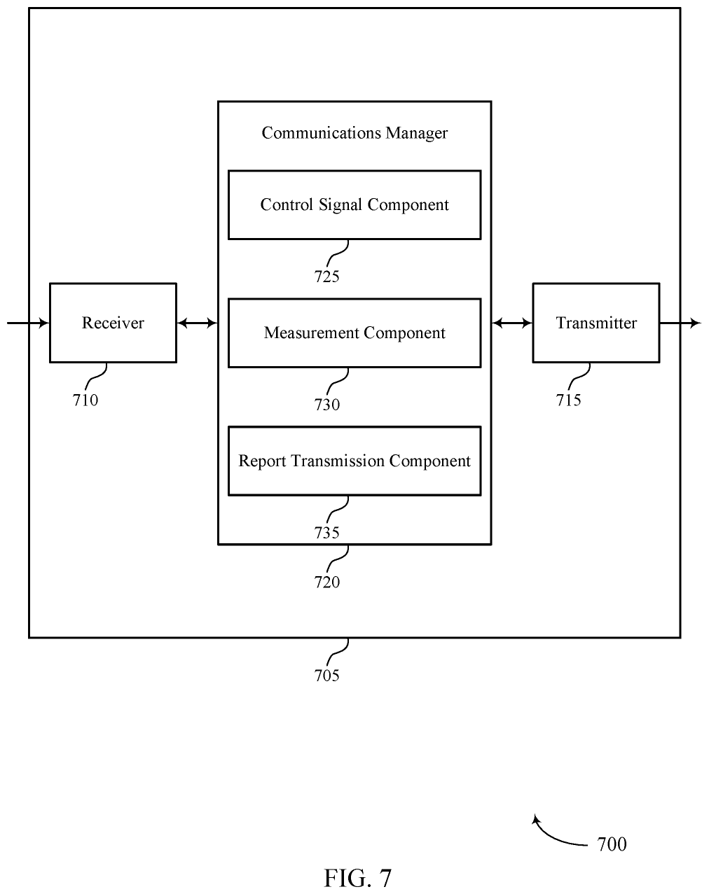

FIG. 7 shows a block diagram 700 of a device 705 that supports received signal strength indicator configuration and reporting in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to received signal strength indicator configuration and reporting). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to received signal strength indicator configuration and reporting). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of received signal strength indicator configuration and reporting as described herein. For example, the communications manager 720 may include a control signal component 725, a measurement component 730, a report transmission component 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The control signal component 725 may be configured as or otherwise support a means for receiving, from a serving base station, control signaling indicating a resource pattern to monitor for interference caused by downlink transmissions from a second base station. The measurement component 730 may be configured as or otherwise support a means for performing a received signal strength indicator measurement of the downlink transmissions from the second base station in accordance with the resource pattern. The report transmission component 735 may be configured as or otherwise support a means for transmitting, to the serving base station, a measurement report including an indication of the received signal strength indicator measurement.

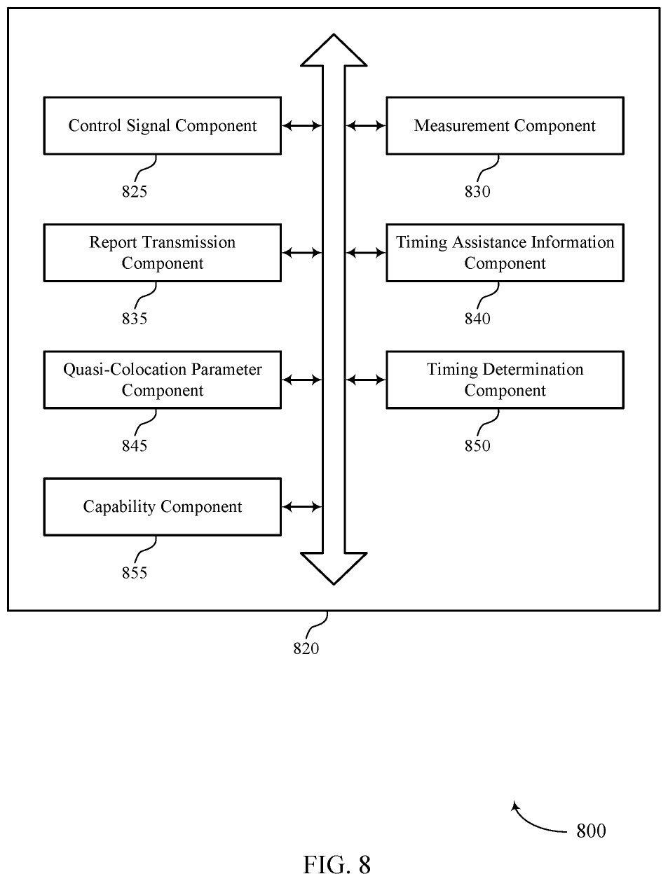

FIG. 8 shows a block diagram 800 of a communications manager 820 that supports received signal strength indicator configuration and reporting in accordance with aspects of the present disclosure. The communications manager 820 may be an example of aspects of a communications manager 620, a communications manager 720, or both, as described herein. The communications manager 820, or various components thereof, may be an example of means for performing various aspects of received signal strength indicator configuration and reporting as described herein. For example, the communications manager 820 may include a control signal component 825, a measurement component 830, a report transmission component 835, a timing assistance information component 840, a quasi-colocation parameter component 845, a timing determination component 850, a capability component 855, or any combination thereof. Each of these components may communicate, directly or indirectly, with one another (e.g., via one or more buses).

The communications manager 820 may support wireless communication at a UE in accordance with examples as disclosed herein. The control signal component 825 may be configured as or otherwise support a means for receiving, from a serving base station, control signaling indicating a resource pattern to monitor for interference caused by downlink transmissions from a second base station. The measurement component 830 may be configured as or otherwise support a means for performing a received signal strength indicator measurement of the downlink transmissions from the second base station in accordance with the resource pattern. The report transmission component 835 may be configured as or otherwise support a means for transmitting, to the serving base station, a measurement report including an indication of the received signal strength indicator measurement.

In some examples, the control signal component 825 may be configured as or otherwise support a means for receiving the control signaling indicating a slot duration, a periodicity, a slot index, or any combination thereof, for the resource pattern, where the received signal strength indicator measurement is performed based on at least one of the slot duration, the periodicity, or the slot index.

In some examples, the control signal component 825 may be configured as or otherwise support a means for receiving the control signaling indicating to report a received signal strength indicator measurement for each resource of a set of multiple resources of the resource pattern. In some examples, the control signal component 825 may be configured as or otherwise support a means for receiving the control signaling indicating that the UE is to transmit the measurement report based on the received signal strength indicator measurement satisfying a threshold.

In some examples, the control signal component 825 may be configured as or otherwise support a means for receiving the control signaling indicating a quantity number of resources from the resource pattern on which the UE is to report, where the measurement report includes indications of received signal strength indicator measurements for the quantity number of resources from the resource pattern. In some examples, to support transmitting the measurement report, the report transmission component 835 may be configured as or otherwise support a means for transmitting, to the serving base station, the measurement report including the received signal strength indicator measurement for a resource of the resource pattern, an index of the resource of the resource pattern, or both.

In some examples, the control signal component 825 may be configured as or otherwise support a means for receiving, from the serving base station, the control signaling indicating that the resource pattern includes a cross link interference resource and a bit indicating for the UE monitor for interference caused by the downlink transmissions from the second base station using the cross link interference resource.

In some examples, to support receiving the control signaling, the control signal component 825 may be configured as or otherwise support a means for receiving the control signaling indicating one or more parameters associated with the resource pattern, where the one or more parameters include at least one of a number of physical resource blocks, a starting physical resource block index for a measurement bandwidth, a symbol location of a received signal strength indicator resource in a slot, a number of slots, a reference subcarrier spacing for the received signal strength indicator measurement, a periodicity, a slot index, or a combination thereof.

In some examples, the timing assistance information component 840 may be configured as or otherwise support a means for receiving timing assistance information corresponding to the downlink transmissions from the second base station, where the received signal strength indicator measurement is performed based on the timing assistance information.

In some examples, the timing assistance information component 840 may be configured as or otherwise support a means for receiving the timing assistance information including a quasi-colocation parameter associated with a synchronization signal block transmission from the second base station. In some examples, the timing determination component 850 may be configured as or otherwise support a means for determining a timing of the synchronization signal block transmission based on the quasi-colocation parameter, where the received signal strength indicator measurement is performed based on the timing.

In some examples, the timing assistance information component 840 may be configured as or otherwise support a means for receiving, from the serving base station, the timing assistance information including an identifier of a second UE served by the second base station. In some examples, the quasi-colocation parameter component 845 may be configured as or otherwise support a means for receiving, from the second UE based on the identifier, a quasi-colocation parameter associated with a synchronization signal block transmission from the second base station. In some examples, the timing determination component 850 may be configured as or otherwise support a means for determining a timing of the synchronization signal block transmission based on the quasi-colocation parameter, where the received signal strength indicator measurement is performed based on the timing.

In some examples, the capability component 855 may be configured as or otherwise support a means for transmitting UE capability information indicating a received signal strength indicator measurement capability for interference measurement, where the control signaling is received based on the UE capability information. In some examples, the received signal strength indicator measurement capability indicates at least one of a maximum number of resources across a set of multiple slots the UE is capable of measuring, a maximum number of measurement resources per slot the UE is capable of measuring, or both.

In some examples, the capability component 855 may be configured as or otherwise support a means for transmitting UE capability information indicating a joint measurement capability that identifies a number of resources the UE is capable of measuring for cross link interference and neighbor cell interference, where the control signaling is received based on the UE capability information. In some examples, the capability component 855 may be configured as or otherwise support a means for transmitting UE capability information indicating a number of cross link interference resources the UE is capable of measuring, where the control signaling is received based on the UE capability information.

In some examples, the control signal component 825 may be configured as or otherwise support a means for receiving, from the serving base station and in response to the measurement report, a control message indicating a reference signal received power measurement resource. In some examples, the measurement component 830 may be configured as or otherwise support a means for performing a reference signal received power measurement of the reference signal received power measurement resource. In some examples, the report transmission component 835 may be configured as or otherwise support a means for transmitting a second measurement report including an indication of the reference signal received power measurement.

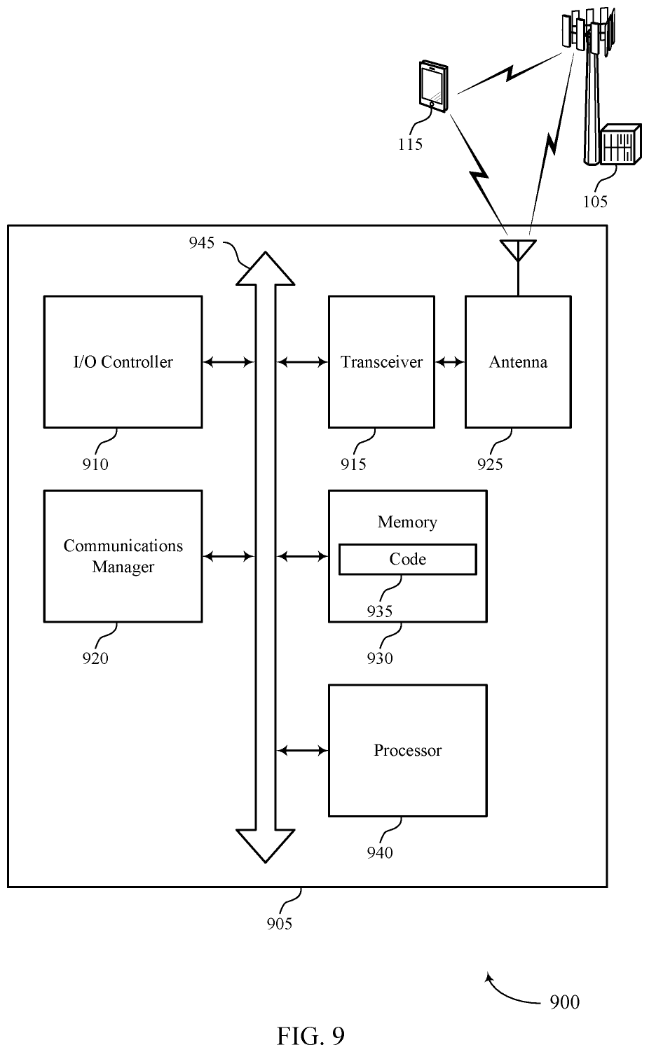

FIG. 9 shows a diagram of a system 900 including a device 905 that supports received signal strength indicator configuration and reporting in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting received signal strength indicator configuration and reporting). For example, the device 905 or a component of the device 905 may include a processor 940 and memory 930 coupled to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving, from a serving base station, control signaling indicating a resource pattern to monitor for interference caused by downlink transmissions from a second base station. The communications manager 920 may be configured as or otherwise support a means for performing a received signal strength indicator measurement of the downlink transmissions from the second base station in accordance with the resource pattern. The communications manager 920 may be configured as or otherwise support a means for transmitting, to the serving base station, a measurement report including an indication of the received signal strength indicator measurement.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of received signal strength indicator configuration and reporting as described herein, or the processor 940 and the memory 930 may be otherwise configured to perform or support such operations.

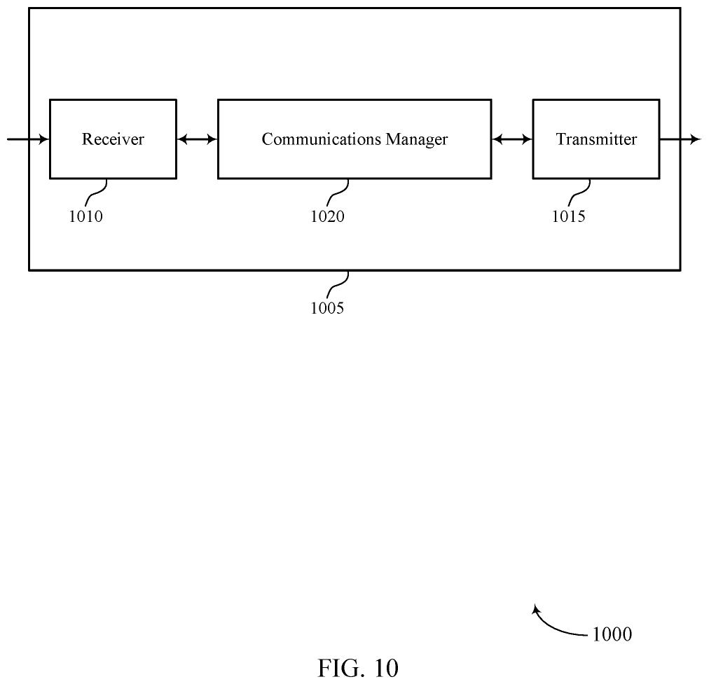

FIG. 10 shows a block diagram 1000 of a device 1005 that supports received signal strength indicator configuration and reporting in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to received signal strength indicator configuration and reporting). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to received signal strength indicator configuration and reporting). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of received signal strength indicator configuration and reporting as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a serving base station in accordance with examples as disclosed herein. For example, the communications manager 1020 may be configured as or otherwise support a means for transmitting, to a UE, control signaling indicating a resource pattern to monitor for interference caused by downlink transmissions from a second base station. The communications manager 1020 may be configured as or otherwise support a means for receiving, from the UE, a measurement report including an indication of a received signal strength indicator measurement of the downlink transmissions from the second base station performed in accordance with the resource pattern.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for reduced processing, reduced power consumption, and more efficient utilization of communication resources.

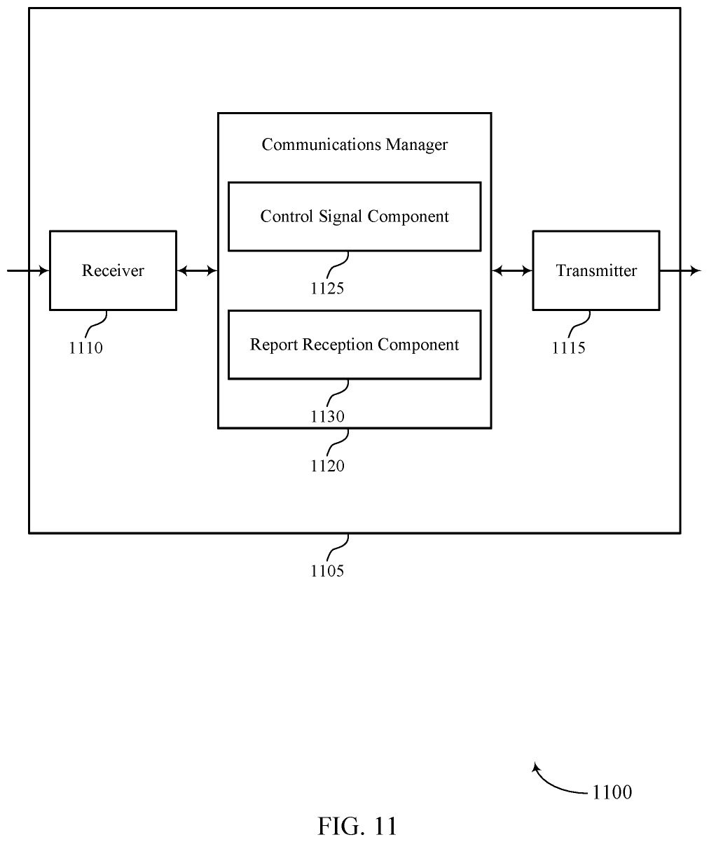

FIG. 11 shows a block diagram 1100 of a device 1105 that supports received signal strength indicator configuration and reporting in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to received signal strength indicator configuration and reporting). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to received signal strength indicator configuration and reporting). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of received signal strength indicator configuration and reporting as described herein. For example, the communications manager 1120 may include a control signal component 1125 a report reception component 1130, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a serving base station in accordance with examples as disclosed herein. The control signal component 1125 may be configured as or otherwise support a means for transmitting, to a UE, control signaling indicating a resource pattern to monitor for interference caused by downlink transmissions from a second base station. The report reception component 1130 may be configured as or otherwise support a means for receiving, from the UE, a measurement report including an indication of a received signal strength indicator measurement of the downlink transmissions from the second base station performed in accordance with the resource pattern.

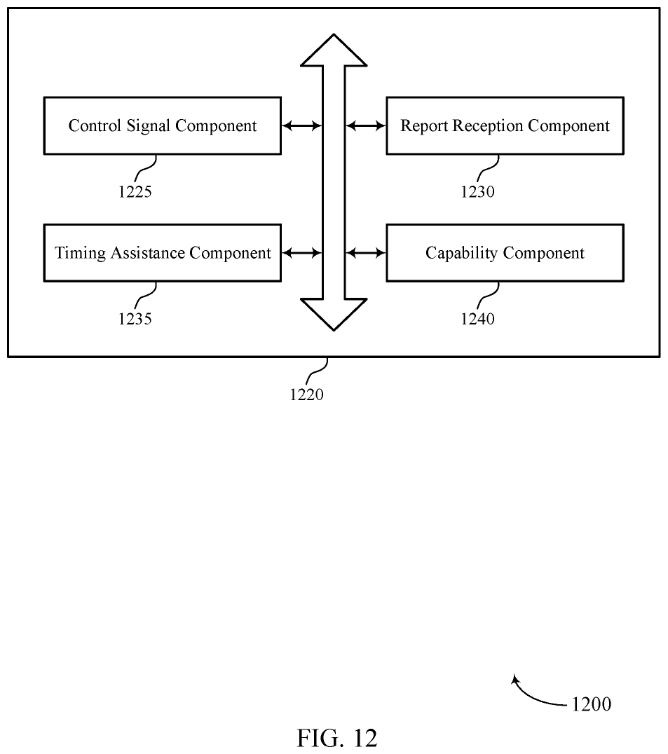

FIG. 12 shows a block diagram 1200 of a communications manager 1220 that supports received signal strength indicator configuration and reporting in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of received signal strength indicator configuration and reporting as described herein. For example, the communications manager 1220 may include a control signal component 1225, a report reception component 1230, a timing assistance component 1235, a capability component 1240, or any combination thereof. Each of these components may communicate, directly or indirectly, with one another (e.g., via one or more buses).

The communications manager 1220 may support wireless communication at a serving base station in accordance with examples as disclosed herein. The control signal component 1225 may be configured as or otherwise support a means for transmitting, to a UE, control signaling indicating a resource pattern to monitor for interference caused by downlink transmissions from a second base station. The report reception component 1230 may be configured as or otherwise support a means for receiving, from the UE, a measurement report including an indication of a received signal strength indicator measurement of the downlink transmissions from the second base station performed in accordance with the resource pattern.

In some examples, the control signal component 1225 may be configured as or otherwise support a means for transmitting the control signaling indicating a slot duration, a periodicity, a slot index, or any combination thereof, for the resource pattern, where the received signal strength indicator measurement is performed based on at least one of the slot duration, the periodicity, or the slot index.

In some examples, the control signal component 1225 may be configured as or otherwise support a means for transmitting the control signaling indicating to report a received signal strength indicator measurement for each resource of a set of multiple resources of the resource pattern. In some examples, the control signal component 1225 may be configured as or otherwise support a means for transmitting the control signaling indicating that the UE is to transmit the measurement report based on the received signal strength indicator measurement satisfying a threshold.

In some examples, the control signal component 1225 may be configured as or otherwise support a means for transmitting the control signaling indicating a quantity number of resources from the resource pattern on which the UE is to report, where the measurement report includes indications of received signal strength indicator measurements for the quantity number of resources from the resource pattern.

In some examples, to support receiving the measurement report, the report reception component 1230 may be configured as or otherwise support a means for receiving, from the UE, the measurement report including the received signal strength indicator measurement for a resource of the resource pattern, an index of the resource of the resource pattern, or both. In some examples, the control signal component 1225 may be configured as or otherwise support a means for transmitting, to the UE, the control signaling indicating that the resource pattern includes a cross link interference resource and a bit indicating for the UE monitor for interference caused by the downlink transmissions from the second base station using the cross link interference resource.

In some examples, to support transmitting the control signaling, the control signal component 1225 may be configured as or otherwise support a means for transmitting the control signaling indicating one or more parameters associated with the resource pattern, where the one or more parameters include at least one of a number of physical resource blocks, a starting physical resource block index for a measurement bandwidth, a symbol location of a received signal strength indicator resource in a slot, a number of slots, a reference subcarrier spacing for the received signal strength indicator measurement, a periodicity, a slot index, or a combination thereof.

In some examples, the timing assistance component 1235 may be configured as or otherwise support a means for transmitting timing assistance information corresponding to the downlink transmissions from the second base station, where the received signal strength indicator measurement is performed based on the timing assistance information, the timing assistance information including a quasi-colocation parameter associated with a synchronization signal block transmission from the second base station or an identifier of a second UE served by the second base station.

In some examples, the capability component 1240 may be configured as or otherwise support a means for receiving UE capability information indicating a received signal strength indicator measurement capability for interference measurement, where the received signal strength indicator measurement capability indicates at least one of a maximum number of resources across a set of multiple slots the UE is capable of measuring, a maximum number of measurement resources per slot the UE is capable of measuring, or both, the control signaling being transmitted based on the UE capability information.

In some examples, the capability component 1240 may be configured as or otherwise support a means for receiving UE capability information indicating a joint measurement capability that identifies a number of resources the UE is capable of measuring for cross link interference and neighbor cell interference, where the control signaling is transmitted based on the UE capability information.

In some examples, the capability component 1240 may be configured as or otherwise support a means for receiving UE capability information indicating a number of cross link interference resources the UE is capable of measuring, where the control signaling is transmitted based on the UE capability information. In some examples, the control signal component 1225 may be configured as or otherwise support a means for transmitting, to the UE and in response to the measurement report, a control message indicating a reference signal received power measurement resource. In some examples, the report reception component 1230 may be configured as or otherwise support a means for receiving a second measurement report including an indication of a reference signal received power measurement of the reference signal received power measurement resource.

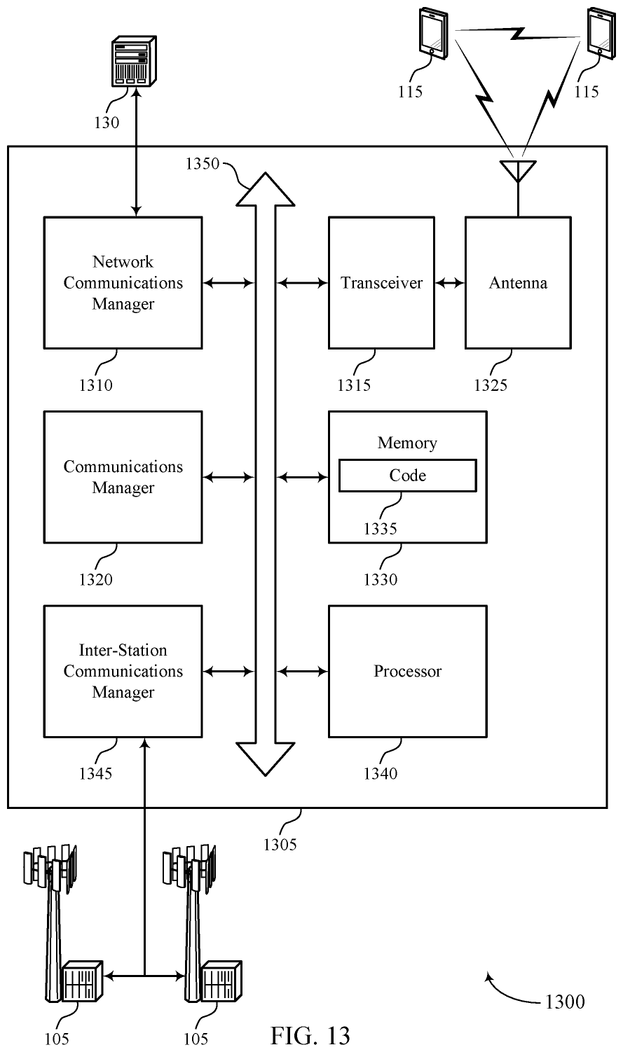

FIG. 13 shows a diagram of a system 1300 including a device 1305 that supports received signal strength indicator configuration and reporting in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting received signal strength indicator configuration and reporting). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communication at a serving base station in accordance with examples as disclosed herein. For example, the communications manager 1320 may be configured as or otherwise support a means for transmitting, to a UE, control signaling indicating a resource pattern to monitor for interference caused by downlink transmissions from a second base station. The communications manager 1320 may be configured as or otherwise support a means for receiving, from the UE, a measurement report including an indication of a received signal strength indicator measurement of the downlink transmissions from the second base station performed in accordance with the resource pattern.

By including or configuring the communications manager 1320 in accordance with examples as described herein, the device 1305 may support techniques for improved communication reliability, reduced latency, and improved user experience.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of received signal strength indicator configuration and reporting as described herein, or the processor 1340 and the memory 1330 may be otherwise configured to perform or support such operations.

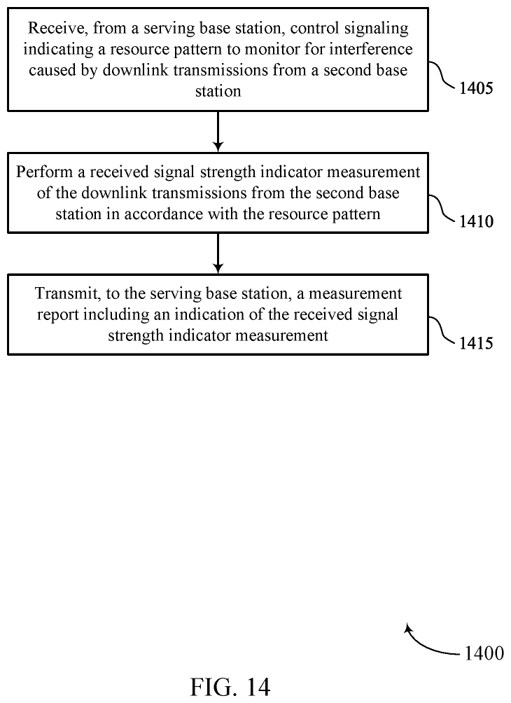

FIG. 14 shows a flowchart illustrating a method 1400 that supports received signal strength indicator configuration and reporting in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving, from a serving base station, control signaling indicating a resource pattern to monitor for interference caused by downlink transmissions from a second base station. The operations of 1405 may be performed in accordance with examples as disclosed herein. In some examples, aspects of the operations of 1405 may be performed by a control signal component 825 as described with reference to FIG. 8.

At 1410, the method may include performing a received signal strength indicator measurement of the downlink transmissions from the second base station in accordance with the resource pattern. The operations of 1410 may be performed in accordance with examples as disclosed herein. In some examples, aspects of the operations of 1410 may be performed by a measurement component 830 as described with reference to FIG. 8.

At 1415, the method may include transmitting, to the serving base station, a measurement report including an indication of the received signal strength indicator measurement. The operations of 1415 may be performed in accordance with examples as disclosed herein. In some examples, aspects of the operations of 1415 may be performed by a report transmission component 835 as described with reference to FIG. 8.

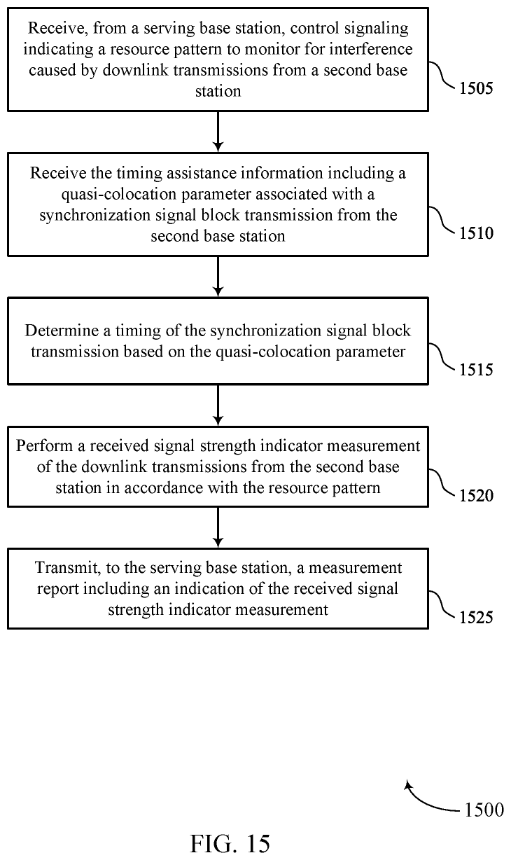

FIG. 15 shows a flowchart illustrating a method 1500 that supports received signal strength indicator configuration and reporting in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving, from a serving base station, control signaling indicating a resource pattern to monitor for interference caused by downlink transmissions from a second base station. The operations of 1505 may be performed in accordance with examples as disclosed herein. In some examples, aspects of the operations of 1505 may be performed by a control signal component 825 as described with reference to FIG. 8.

At 1510, the method may include receiving the timing assistance information including a quasi-colocation parameter associated with a synchronization signal block transmission from the second base station. The operations of 1510 may be performed in accordance with examples as disclosed herein. In some examples, aspects of the operations of 1510 may be performed by a timing assistance information component 840 as described with reference to FIG. 8.

At 1515, the method may include determining a timing of the synchronization signal block transmission based on the quasi-colocation parameter. The operations of 1515 may be performed in accordance with examples as disclosed herein. In some examples, aspects of the operations of 1515 may be performed by a timing determination component 850 as described with reference to FIG. 8.

At 1520, the method may include performing a received signal strength indicator measurement of the downlink transmissions from the second base station in accordance with the resource pattern. In some examples, the received signal strength indicator measurement is performed based on the timing. The operations of 1520 may be performed in accordance with examples as disclosed herein. In some examples, aspects of the operations of 1520 may be performed by a measurement component 830 as described with reference to FIG. 8.

At 1525, the method may include transmitting, to the serving base station, a measurement report including an indication of the received signal strength indicator measurement. The operations of 1525 may be performed in accordance with examples as disclosed herein. In some examples, aspects of the operations of 1525 may be performed by a report transmission component 835 as described with reference to FIG. 8.

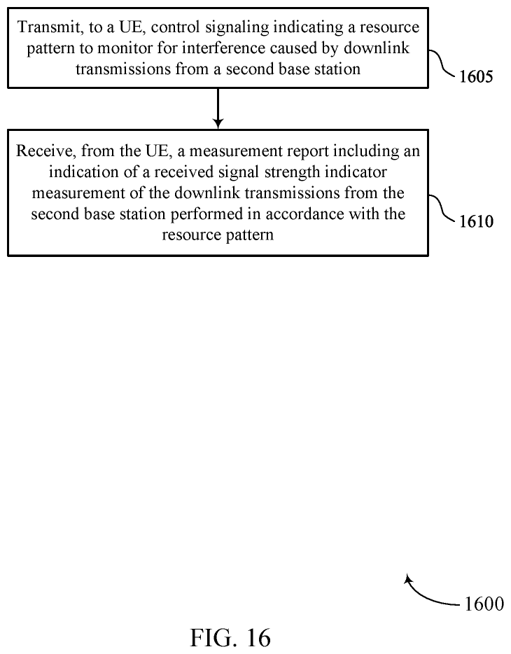

FIG. 16 shows a flowchart illustrating a method 1600 that supports received signal strength indicator configuration and reporting in accordance with aspects of the present disclosure. The operations of the method 1600 may be implemented by a base station or its components as described herein. For example, the operations of the method 1600 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1605, the method may include transmitting, to a UE, control signaling indicating a resource pattern to monitor for interference caused by downlink transmissions from a second base station. The operations of 1605 may be performed in accordance with examples as disclosed herein. In some examples, aspects of the operations of 1605 may be performed by a control signal component 1225 as described with reference to FIG. 12.

At 1610, the method may include receiving, from the UE, a measurement report including an indication of a received signal strength indicator measurement of the downlink transmissions from the second base station performed in accordance with the resource pattern. The operations of 1610 may be performed in accordance with examples as disclosed herein. In some examples, aspects of the operations of 1610 may be performed by a report reception component 1230 as described with reference to FIG. 12.

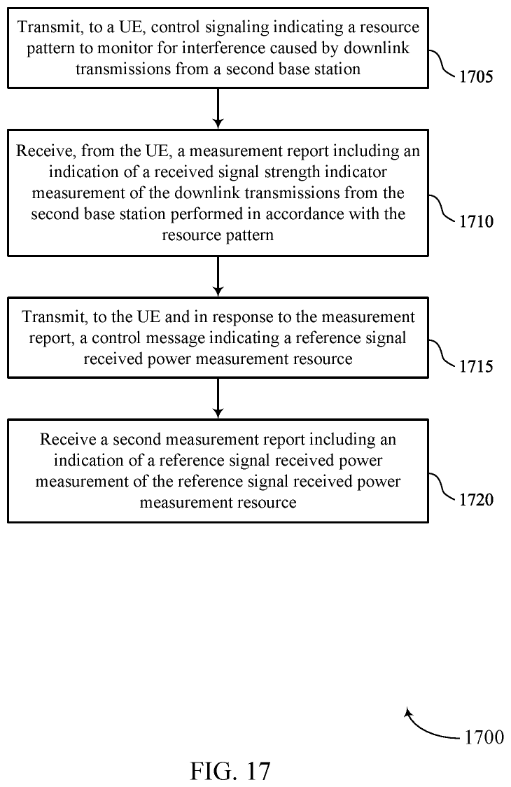

FIG. 17 shows a flowchart illustrating a method 1700 that supports received signal strength indicator configuration and reporting in accordance with aspects of the present disclosure. The operations of the method 1700 may be implemented by a base station or its components as described herein. For example, the operations of the method 1700 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1705, the method may include transmitting, to a UE, control signaling indicating a resource pattern to monitor for interference caused by downlink transmissions from a second base station. The operations of 1705 may be performed in accordance with examples as disclosed herein. In some examples, aspects of the operations of 1705 may be performed by a control signal component 1225 as described with reference to FIG. 12.

At 1710, the method may include receiving, from the UE, a measurement report including an indication of a received signal strength indicator measurement of the downlink transmissions from the second base station performed in accordance with the resource pattern. The operations of 1710 may be performed in accordance with examples as disclosed herein. In some examples, aspects of the operations of 1710 may be performed by a report reception component 1230 as described with reference to FIG. 12.

At 1715, the method may include transmitting, to the UE and in response to the measurement report, a control message indicating a reference signal received power measurement resource. The operations of 1715 may be performed in accordance with examples as disclosed herein. In some examples, aspects of the operations of 1715 may be performed by a control signal component 1225 as described with reference to FIG. 12.

At 1720, the method may include receiving a second measurement report including an indication of a reference signal received power measurement of the reference signal received power measurement resource. The operations of 1720 may be performed in accordance with examples as disclosed herein. In some examples, aspects of the operations of 1720 may be performed by a report reception component 1230 as described with reference to FIG. 12.

The following provides an overview of aspects of the present disclosure:

Aspect 1: A method for wireless communication at a UE, comprising: receiving, from a serving base station, control signaling indicating a resource pattern to monitor for interference caused by downlink transmissions from a second base station: performing a received signal strength indicator measurement of the downlink transmissions from the second base station in accordance with the resource pattern: and transmitting, to the serving base station, a measurement report comprising an indication of the received signal strength indicator measurement.

Aspect 2: The method of aspect 1, further comprising: receiving the control signaling indicating a slot duration, a periodicity, a slot index, or any combination thereof, for the resource pattern, wherein the received signal strength indicator measurement is performed based at least in part on at least one of the slot duration, the periodicity, or the slot index.

Aspect 3: The method of any of aspects 1 through 2, further comprising: receiving the control signaling indicating to report a received signal strength indicator measurement for each resource of a plurality of resources of the resource pattern.

Aspect 4: The method of any of aspects 1 through 3, further comprising: receiving the control signaling indicating that the UE is to transmit the measurement report based at least in part on the received signal strength indicator measurement satisfying a threshold.

Aspect 5: The method of any of aspects 1 through 4, further comprising: receiving the control signaling indicating a quantity number of resources from the resource pattern on which the UE is to report, wherein the measurement report comprises indications of received signal strength indicator measurements for the quantity number of resources from the resource pattern.

Aspect 6: The method of any of aspects 1 through 5, wherein transmitting the measurement report further comprises: transmitting, to the serving base station, the measurement report comprising the received signal strength indicator measurement for a resource of the resource pattern, an index of the resource of the resource pattern, or both.

Aspect 7: The method of any of aspects 1 through 6, further comprising: receiving, from the serving base station, the control signaling indicating that the resource pattern comprises a cross link interference resource and a bit indicating for the UE monitor for interference caused by the downlink transmissions from the second base station using the cross link interference resource.

Aspect 8: The method of any of aspects 1 through 7, wherein receiving the control signaling further comprises: receiving the control signaling indicating one or more parameters associated with the resource pattern, wherein the one or more parameters comprise at least one of a number of physical resource blocks, a starting physical resource block index for a measurement bandwidth, a symbol location of a received signal strength indicator resource in a slot, a number of slots, a reference subcarrier spacing for the received signal strength indicator measurement, a periodicity, a slot index, or a combination thereof.

Aspect 9: The method of any of aspects 1 through 8, further comprising: receiving timing assistance information corresponding to the downlink transmissions from the second base station, wherein the received signal strength indicator measurement is performed based at least in part on the timing assistance information.

Aspect 10: The method of aspect 9, further comprising: receiving the timing assistance information comprising a quasi-colocation parameter associated with a synchronization signal block transmission from the second base station: and determining a timing of the synchronization signal block transmission based at least in part on the quasi-colocation parameter, wherein the received signal strength indicator measurement is performed based at least in part on the timing.

Aspect 11: The method of any of aspects 1 through 10, further comprising: receiving, from the serving base station, the timing assistance information comprising an identifier of a second UE served by the second base station: receiving, from the second UE based at least in part on the identifier, a quasi-colocation parameter associated with a synchronization signal block transmission from the second base station: and determining a timing of the synchronization signal block transmission based at least in part on the quasi-colocation parameter, wherein the received signal strength indicator measurement is performed based at least in part on the timing.

Aspect 12: The method of any of aspects 1 through 11, further comprising: transmitting UE capability information indicating a received signal strength indicator measurement capability for interference measurement, wherein the control signaling is received based at least in part on the UE capability information.

Aspect 13: The method of aspect 12, wherein the received signal strength indicator measurement capability indicates at least one of a maximum number of resources across a plurality of slots the UE is capable of measuring, a maximum number of measurement resources per slot the UE is capable of measuring, or both.

Aspect 14: The method of any of aspects 1 through 13, further comprising: transmitting UE capability information indicating a joint measurement capability that identifies a number of resources the UE is capable of measuring for cross link interference and neighbor cell interference, wherein the control signaling is received based at least in part on the UE capability information.

Aspect 15: The method of any of aspects 1 through 14, further comprising: transmitting UE capability information indicating a number of cross link interference resources the UE is capable of measuring, wherein the control signaling is received based at least in part on the UE capability information.

Aspect 16: The method of any of aspects 1 through 15, further comprising: receiving, from the serving base station and in response to the measurement report, a control message indicating a reference signal received power measurement resource: performing a reference signal received power measurement of the reference signal received power measurement resource: and transmitting a second measurement report comprising an indication of the reference signal received power measurement.

Aspect 17: A method for wireless communication at a serving base station, comprising: transmitting, to a UE, control signaling indicating a resource pattern to monitor for interference caused by downlink transmissions from a second base station: and receiving, from the UE, a measurement report comprising an indication of a received signal strength indicator measurement of the downlink transmissions from the second base station performed in accordance with the resource pattern.

Aspect 18: The method of aspect 17, further comprising: transmitting the control signaling indicating a slot duration, a periodicity, a slot index, or any combination thereof, for the resource pattern, wherein the received signal strength indicator measurement is performed based at least in part on at least one of the slot duration, the periodicity, or the slot index.

Aspect 19: The method of any of aspects 17 through 18, further comprising: transmitting the control signaling indicating to report a received signal strength indicator measurement for each resource of a plurality of resources of the resource pattern.

Aspect 20: The method of any of aspects 17 through 19, further comprising: transmitting the control signaling indicating that the UE is to transmit the measurement report based at least in part on the received signal strength indicator measurement satisfying a threshold.

Aspect 21: The method of any of aspects 17 through 20, further comprising: transmitting the control signaling indicating a quantity number of resources from the resource pattern on which the UE is to report, wherein the measurement report comprises indications of received signal strength indicator measurements for the quantity number of resources from the resource pattern.

Aspect 22: The method of any of aspects 17 through 21, wherein receiving the measurement report further comprises: receiving, from the UE, the measurement report comprising the received signal strength indicator measurement for a resource of the resource pattern, an index of the resource of the resource pattern, or both.

Aspect 23: The method of any of aspects 17 through 22, further comprising: transmitting, to the UE, the control signaling indicating that the resource pattern comprises a cross link interference resource and a bit indicating for the UE monitor for interference caused by the downlink transmissions from the second base station using the cross link interference resource.

Aspect 24: The method of any of aspects 17 through 23, wherein transmitting the control signaling further comprises: transmitting the control signaling indicating one or more parameters associated with the resource pattern, wherein the one or more parameters comprise at least one of a number of physical resource blocks, a starting physical resource block index for a measurement bandwidth, a symbol location of a received signal strength indicator resource in a slot, a number of slots, a reference subcarrier spacing for the received signal strength indicator measurement, a periodicity, a slot index, or a combination thereof.

Aspect 25: The method of any of aspects 17 through 24, further comprising: transmitting timing assistance information corresponding to the downlink transmissions from the second base station, wherein the received signal strength indicator measurement is performed based at least in part on the timing assistance information, the timing assistance information comprising a quasi-colocation parameter associated with a synchronization signal block transmission from the second base station or an identifier of a second UE served by the second base station.

Aspect 26: The method of any of aspects 17 through 25, further comprising: receiving UE capability information indicating a received signal strength indicator measurement capability for interference measurement, wherein the received signal strength indicator measurement capability indicates at least one of a maximum number of resources across a plurality of slots the UE is capable of measuring, a maximum number of measurement resources per slot the UE is capable of measuring, or both, the control signaling being transmitted based at least in part on the UE capability information.

Aspect 27: The method of any of aspects 17 through 26, further comprising: receiving UE capability information indicating a joint measurement capability that identifies a number of resources the UE is capable of measuring for cross link interference and neighbor cell interference, wherein the control signaling is transmitted based at least in part on the UE capability information.

Aspect 28: The method of any of aspects 17 through 27, further comprising: receiving UE capability information indicating a number of cross link interference resources the UE is capable of measuring, wherein the control signaling is transmitted based at least in part on the UE capability information.

Aspect 29: The method of any of aspects 17 through 28, further comprising: transmitting, to the UE and in response to the measurement report, a control message indicating a reference signal received power measurement resource: and receiving a second measurement report comprising an indication of a reference signal received power measurement of the reference signal received power measurement resource.

Aspect 30: An apparatus for wireless communication at a UE, comprising a processor: memory coupled with the processor: and instructions stored in the memory and executable by the processor to cause the apparatus to perform a method of any of aspects 1 through 16.

Aspect 31: An apparatus for wireless communication at a UE, comprising at least one means for performing a method of any of aspects 1 through 16.

Aspect 32: A non-transitory computer-readable medium storing code for wireless communication at a UE, the code comprising instructions executable by a processor to perform a method of any of aspects 1 through 16.

Aspect 33: An apparatus for wireless communication at a serving base station, comprising a processor: memory coupled with the processor: and instructions stored in the memory and executable by the processor to cause the apparatus to perform a method of any of aspects 17 through 29.

Aspect 34: An apparatus for wireless communication at a serving base station, comprising at least one means for performing a method of any of aspects 17 through 29.

Aspect 35: A non-transitory computer-readable medium storing code for wireless communication at a serving base station, the code comprising instructions executable by a processor to perform a method of any of aspects 17 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a serving base station, control signaling indicating a resource pattern to monitor for interference caused by downlink transmissions from a second base station;
performing a received signal strength indicator measurement of the downlink transmissions from the second base station in accordance with the resource pattern; and
transmitting, to the serving base station, a measurement report comprising an indication of the received signal strength indicator measurement.

2. The method of claim 1, further comprising:
receiving the control signaling indicating a slot duration, a periodicity, a slot index, or any combination thereof, for the resource pattern, wherein the received signal strength indicator measurement is performed based at least in part on at least one of the slot duration, the periodicity, or the slot index.

3. The method of claim 1, further comprising:
receiving the control signaling indicating to report a received signal strength indicator measurement for each resource of a plurality of resources of the resource pattern.

4. The method of claim 1, further comprising:
receiving the control signaling indicating that the UE is to transmit the measurement report based at least in part on the received signal strength indicator measurement satisfying a threshold.

5. The method of claim 1, further comprising:
receiving the control signaling indicating a quantity number of resources from the resource pattern on which the UE is to report, wherein the measurement report comprises indications of received signal strength indicator measurements for the quantity number of resources from the resource pattern.

6. The method of claim 1, wherein transmitting the measurement report further comprises:
transmitting, to the serving base station, the measurement report comprising the received signal strength indicator measurement for a resource of the resource pattern, an index of the resource of the resource pattern, or both.

7. The method of claim 1, further comprising:
receiving, from the serving base station, the control signaling indicating that the resource pattern comprises a cross link interference resource and a bit indicating for the UE monitor for interference caused by the downlink transmissions from the second base station using the cross link interference resource.

8. The method of claim 1, wherein receiving the control signaling further comprises:
receiving the control signaling indicating one or more parameters associated with the resource pattern, wherein the one or more parameters comprise at least one of a number of physical resource blocks, a starting physical resource block index for a measurement bandwidth, a symbol location of a received signal strength indicator resource in a slot, a number of slots, a reference subcarrier spacing for the received signal strength indicator measurement, a periodicity, a slot index, or a combination thereof.

9. The method of claim 1, further comprising:
receiving timing assistance information corresponding to the downlink transmissions from the second base station, wherein the received signal strength indicator measurement is performed based at least in part on the timing assistance information.

10. The method of claim 9, further comprising:
receiving the timing assistance information comprising a quasi-colocation parameter associated with a synchronization signal block transmission from the second base station; and
determining a timing of the synchronization signal block transmission based at least in part on the quasi-colocation parameter, wherein the received signal strength indicator measurement is performed based at least in part on the timing.

11. The method of claim 1, further comprising:
receiving, from the serving base station, the timing assistance information comprising an identifier of a second UE served by the second base station;
receiving, from the second UE based at least in part on the identifier, a quasi-colocation parameter associated with a synchronization signal block transmission from the second base station; and
determining a timing of the synchronization signal block transmission based at least in part on the quasi-colocation parameter, wherein the received signal strength indicator measurement is performed based at least in part on the timing.

12. The method of claim 1, further comprising:
transmitting UE capability information indicating a received signal strength indicator measurement capability for interference measurement, wherein the control signaling is received based at least in part on the UE capability information.

13. The method of claim 12, wherein the received signal strength indicator measurement capability indicates at least one of a maximum number of resources across a plurality of slots the UE is capable of measuring, a maximum number of measurement resources per slot the UE is capable of measuring, or both.

14. The method of claim 1, further comprising:
transmitting UE capability information indicating a joint measurement capability that identifies a number of resources the UE is capable of measuring for cross link interference and neighbor cell interference, wherein the control signaling is received based at least in part on the UE capability information.

15. The method of claim 1, further comprising:
transmitting UE capability information indicating a number of cross link interference resources the UE is capable of measuring, wherein the control signaling is received based at least in part on the UE capability information.

16. The method of claim 1, further comprising:
receiving, from the serving base station and in response to the measurement report, a control message indicating a reference signal received power measurement resource;
performing a reference signal received power measurement of the reference signal received power measurement resource; and
transmitting a second measurement report comprising an indication of the reference signal received power measurement.

17. A method for wireless communication at a serving base station, comprising:
transmitting, to a user equipment (UE), control signaling indicating a resource pattern to monitor for interference caused by downlink transmissions from a second base station; and
receiving, from the UE, a measurement report comprising an indication of a received signal strength indicator measurement of the downlink transmissions from the second base station performed in accordance with the resource pattern.

18. The method of claim 17, further comprising:
transmitting the control signaling indicating a slot duration, a periodicity, a slot index, or any combination thereof, for the resource pattern, wherein the received signal strength indicator measurement is performed based at least in part on at least one of the slot duration, the periodicity, or the slot index.

19. The method of claim 17, further comprising:
transmitting the control signaling indicating to report a received signal strength indicator measurement for each resource of a plurality of resources of the resource pattern.

20. The method of claim 17, further comprising:
transmitting the control signaling indicating that the UE is to transmit the measurement report based at least in part on the received signal strength indicator measurement satisfying a threshold.

21. The method of claim 17, further comprising:
transmitting the control signaling indicating a quantity number of resources from the resource pattern on which the UE is to report, wherein the measurement report comprises indications of received signal strength indicator measurements for the quantity number of resources from the resource pattern.

22. The method of claim 17, wherein receiving the measurement report further comprises:
receiving, from the UE, the measurement report comprising the received signal strength indicator measurement for a resource of the resource pattern, an index of the resource of the resource pattern, or both.

23. The method of claim 17, further comprising:
transmitting, to the UE, the control signaling indicating that the resource pattern comprises a cross link interference resource and a bit indicating for the UE monitor for interference caused by the downlink transmissions from the second base station using the cross link interference resource.

24. The method of claim 17, wherein transmitting the control signaling further comprises:
transmitting the control signaling indicating one or more parameters associated with the resource pattern, wherein the one or more parameters comprise at least one of a number of physical resource blocks, a starting physical resource block index for a measurement bandwidth, a symbol location of a received signal strength indicator resource in a slot, a number of slots, a reference subcarrier spacing for the received signal strength indicator measurement, a periodicity, a slot index, or a combination thereof.

25. The method of claim 17, further comprising:
transmitting timing assistance information corresponding to the downlink transmissions from the second base station, wherein the received signal strength indicator measurement is performed based at least in part on the timing assistance information, the timing assistance information comprising a quasi-colocation parameter associated with a synchronization signal block transmission from the second base station or an identifier of a second UE served by the second base station.

26. The method of claim 17, further comprising:
receiving UE capability information indicating a received signal strength indicator measurement capability for interference measurement, wherein the received signal strength indicator measurement capability indicates at least one of a maximum number of resources across a plurality of slots the UE is capable of measuring, a maximum number of measurement resources per slot the UE is capable of measuring, or both, the control signaling being transmitted based at least in part on the UE capability information.

27. The method of claim 17, further comprising:
receiving UE capability information indicating a joint measurement capability that identifies a number of resources the UE is capable of measuring for cross link interference and neighbor cell interference, wherein the control signaling is transmitted based at least in part on the UE capability information.

28. The method of claim 17, further comprising:
receiving UE capability information indicating a number of cross link interference resources the UE is capable of measuring, wherein the control signaling is transmitted based at least in part on the UE capability information.

29. An apparatus for wireless communication at a user equipment (UE), comprising:
a processor;
memory coupled with the processor; and
instructions stored in the memory and executable by the processor to cause the apparatus to:
receive, from a serving base station, control signaling indicating a resource pattern to monitor for interference caused by downlink transmissions from a second base station;
perform a received signal strength indicator measurement of the downlink transmissions from the second base station in accordance with the resource pattern; and
transmit, to the serving base station, a measurement report comprising an indication of the received signal strength indicator measurement.

30. An apparatus for wireless communication at a serving base station, comprising:
a processor;
memory coupled with the processor; and
instructions stored in the memory and executable by the processor to cause the apparatus to:
transmit, to a user equipment (UE), control signaling indicating a resource pattern to monitor for interference caused by downlink transmissions from a second base station; and
receive, from the UE, a measurement report comprising an indication of a received signal strength indicator measurement of the downlink transmissions from the second base station performed in accordance with the resource pattern.
